(19) United States
(12) Patent Application Publication
(10) Pub. No.: US 2016/0054563 A9
(43) Pub. Date: Feb. 25, 2016

(54) 3-DIMENSIONAL (3-D) NAVIGATION

(71) Applicant: Honda Motor Co., Ltd., Tokyo (JP)

(72) Inventors: Kikuo Fujimura, Palo Alto, CA (US); Victor Ng-Thow-Hing, Sunnyvale, CA (US)

(21) Appl. No.: 14/041,614

(22) Filed: Sep. 30, 2013

Related U.S. Application Data
(63) Continuation-in-part of application No. 13/832,918, filed on Mar. 15, 2013, now Pat. No. 9,164,281.
Application No. 13/832,918 is a continuation-in-part of application No. 13/803,288, filed on Mar. 14, 2013, now Pat. No. 9,064,420.

(51) Int. Cl. G02B 27/01

(52) U.S. Cl. CPC G02B 27/01

(57) ABSTRACT

One or more embodiments of techniques or systems for 3-dimensional (3-D) navigation are provided herein. A heads-up display (HUD) component can project graphic elements on focal planes around an environment surrounding a vehicle. The HUD component can cause these graphic elements to appear volumetric or 3-D by moving or adjusting a distance between a focal plane and the vehicle. Additionally, a target position for graphic elements can be adjusted. This enables the HUD component to project graphic elements as moving avatars. In other words, adjusting the focal plane distance and the target position enables graphic elements to be projected in three dimensions along an x, y, and z axis. Further, a moving avatar can be ‘animated’ by sequentially projecting the avatar on different focal planes, thereby providing an occupant with the perception that the avatar is moving towards or away from the vehicle.

### CROSS-REFERENCE TO RELATED APPLICATIONS

This application is a continuation-in-part (CIP) of pending U.S. Non-Provisional patent application Ser. No. 13/832,918 (Attorney Docket No.: HRA-36332.01) entitled “VOLUMETRIC HEADS-UP DISPLAY WITH DYNAMIC FOCAL PLANE”, filed on Mar. 15, 2013. The entirety of the above-noted application is incorporated by reference herein.

### BACKGROUND

To improve driver convenience, a vehicle may be a provided with a heads-up display (HUD) which displays information to the driver. The information displayed by the HUD may be projected onto the windshield of the vehicle to present the information in the driver's view while the driver is driving. By displaying the information in the driver's view, the driver does not need to look away from the windshield (e.g., toward an instrument display on a center dashboard) while driving to see the presented information.

The HUD may present vehicle information typically displayed in the vehicle's center dashboard, such as information related to the vehicle's speed, fuel level, engine temperature, etc. Additionally, the HUD may present map information and communication events (e.g., navigation instructions, driving instructions, warnings, alerts, etc.) to the driver. The vehicle HUD may present the information to the driver in a manner similar to that employed by the vehicle dashboard, such as by displaying gauges and text boxes which appear as graphic elements on the windshield. Additionally, the vehicle HUD may present augmented reality graphic elements which augment a physical environment surrounding the vehicle with real-time information.

However, existing HUD devices used in vehicles may not be capable of presenting augmented reality graphic elements with consistent depth cues. Accordingly, augmented reality graphic elements presented by existing vehicle HUDs may be presented as superficial overlays.

### BRIEF DESCRIPTION

This brief description is provided to introduce a selection of concepts in a simplified form that are described below in the detailed description. This brief description is not intended to be an extensive overview of the claimed subject matter, identify key factors or essential features of the claimed subject matter, nor is it intended to be used to limit the scope of the claimed subject matter.

According to one aspect, a vehicle heads-up display device for displaying graphic elements in view of a driver of a vehicle includes a first projector and a first actuator. The first projector can be configured to project a first graphic element on a first focal plane in view of the driver. The first focal plane may be oriented substantially perpendicularly to a line-of-sight of the driver and a distance away from the vehicle. The first projector can be mounted on the first actuator. The first actuator may be configured to linearly move the first projector. Linearly moving the first projector can cause the first focal plane of the first graphic element to move in a direction of the line-of-sight of the driver.

According to another aspect, a vehicular heads-up display system includes a vehicle heads-up display device and a controller. The vehicle heads-up display device displays graphic elements in view of a driver of a vehicle, and includes a first projector and a second projector. The first projector can be configured to project a first graphic element on a first focal plane in view of the driver. The first focal plane can be oriented substantially perpendicularly to a line-of-sight of the driver. The first projector can be configured to move the first focal plane in a direction of the line-of-sight of the driver. The second projector can be configured to project a second graphic element on a second focal plane in view of the driver. The second focal plane may be static and oriented substantially parallel to a ground surface. The controller can be configured to communicate with one or more associated vehicle control systems and to control the vehicle heads-up display device to display the first and second graphic elements based on communication with one or more of the associated vehicle control systems.

According to yet another aspect, a method for presenting augmented reality graphic elements in a vehicle heads-up display includes projecting a first graphic element on a first focal plane in view of a driver, and a second graphic element on a second focal plane in view of the driver. The first focal plane may be oriented substantially perpendicularly to a line-of-sight of the driver, and the second focal plane may be static and oriented substantially parallel to a ground surface. The method can include moving or adjusting the first focal plane in a direction of the line-of-sight of the driver.

One or more embodiments of techniques or systems for 3-dimensional (3-D) navigation are provided herein. For example, a system for 3-D navigation can project a graphic element or avatar that appears to move in view of an occupant of a vehicle. In one or more embodiments, a heads-up display component (HUD) component can be configured to project the graphic element or avatar on one or more focal planes in an environment surrounding a vehicle. In other words, the HUD component can project graphic elements or avatars at adjustable distances or adjustable focal planes to provide an occupant of a vehicle with the perception that an avatar or graphic element is moving, flying, animated, etc.

As an example, the HUD component may be configured to ‘animate’ or provide movement for an avatar by sequentially projecting the avatar on one or more different focal planes. Projection on to these focal planes may be achieved utilizing an actuator to move a projector of the HUD component, for example. As a result of this, depth cues such as accommodation and vergence associated with a graphic element or avatar are generally preserved. When a route is generated from a first location to a second location, the HUD component can generate one or more graphic elements for a driver or occupant of a vehicle to ‘follow’. Because the HUD component can project onto multiple focal planes or move projected graphic elements from one focal plane to another, graphic elements or projected images can appear much more ‘real’, similar to an image seen in a mirror.

When an occupant of a vehicle requests navigation guidance, a graphic element, such as an avatar, may be provided. The avatar may appear to move, glide, fly, etc. in front of the vehicle, similar to what an occupant or driver would see if they were following a friend's vehicle, for example. Additionally, the avatar could appear to navigate around obstructions, obstacles, pedestrians, debris, potholes, etc. as a real vehicle would. In one or more embodiments, the avatar could ‘drive’, move, appear to move, etc. according to real-time traffic. For example, if a route takes a driver or a vehicle across train tracks, the avatar may stop at the train tracks when a train is crossing. As another example, the avatar may change lanes in a manner such that the avatar does not appear to ‘hit’ another vehicle or otherwise interfere with traffic.

The following description and annexed drawings set forth certain illustrative aspects and implementations. These are indicative of but a few of the various ways in which one or more aspects are employed. Other aspects, advantages, or novel features of the disclosure will become apparent from the following detailed description when considered in conjunction with the annexed drawings.

### BRIEF DESCRIPTION OF THE DRAWINGS

Aspects of the disclosure are understood from the following detailed description when read with the accompanying drawings. Elements, structures, etc. of the drawings may not necessarily be drawn to scale. Accordingly, the dimensions of the same may be arbitrarily increased or reduced for clarity of discussion, for example.

FIG. 1 is an illustration of an example schematic diagram of a vehicular heads-up display system, according to one or more embodiments.

FIG. 2 is an illustration of an example schematic diagram of a vehicle in which a vehicular heads-up display system is provided, according to one or more embodiments.

FIG. 3 is an illustration of an example side view of a vehicle and four focal planes on which graphic elements are projected by a vehicular heads-up display system, according to one or more embodiments.

FIG. 4 is an illustration of an example view of a driver while driving a vehicle, looking through a windshield of the vehicle, and exemplary graphic elements projected by a vehicular heads-up display system, according to one or more embodiments.

FIG. 5 is an illustration of an example component diagram of a system for 3-D navigation, according to one or more embodiments.

FIG. 6 is an illustration of an example flow diagram of a method for 3-D navigation, according to one or more embodiments.

FIG. 7A is an illustration of an example avatar for 3-D navigation, according to one or more embodiments.

FIG. 7B is an illustration of an example avatar for 3-D navigation, according to one or more embodiments.

FIG. 8A is an illustration of an example avatar for 3-D navigation, according to one or more embodiments.

FIG. 8B is an illustration of an example avatar for 3-D navigation, according to one or more embodiments.

FIG. 9A is an illustration of an example avatar for 3-D navigation, according to one or more embodiments.

FIG. 9B is an illustration of an example avatar for 3-D navigation, according to one or more embodiments.

FIG. 10 is an illustration of an example computer-readable medium or computer-readable device including processor-executable instructions configured to embody one or more of the provisions set forth herein, according to one or more embodiments.

FIG. 11 is an illustration of an example computing environment where one or more of the provisions set forth herein are implemented, according to one or more embodiments.

### DETAILED DESCRIPTION

Embodiments or examples, illustrated in the drawings are disclosed below using specific language. It will nevertheless be understood that the embodiments or examples are not intended to be limiting. Any alterations and modifications in the disclosed embodiments, and any further applications of the principles disclosed in this document are contemplated as would normally occur to one of ordinary skill in the pertinent art.

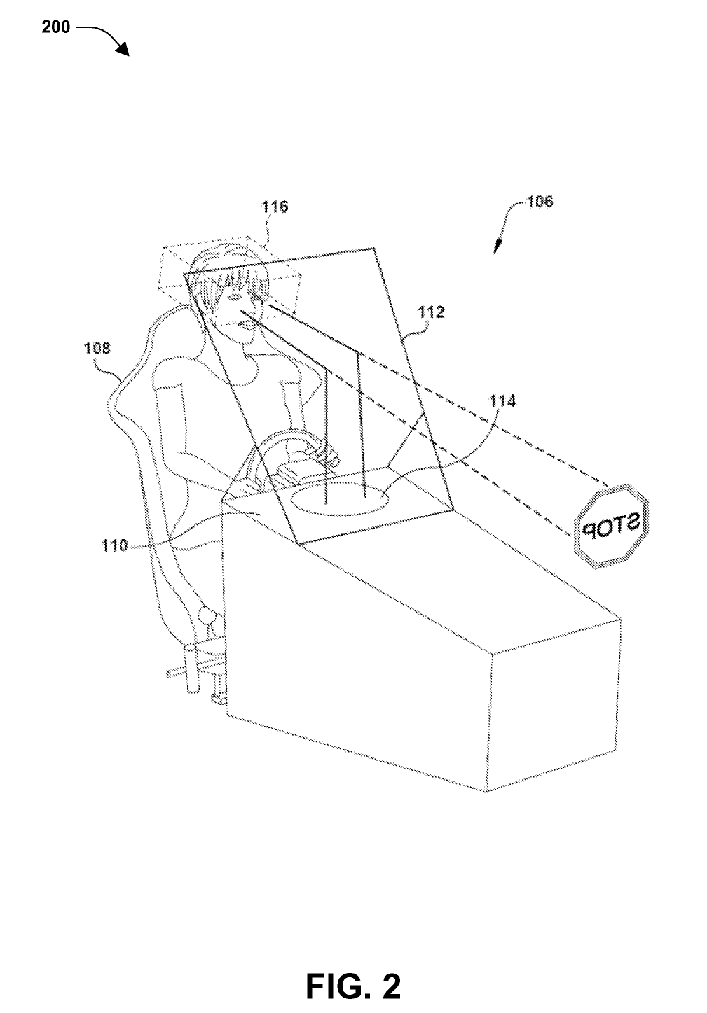

For one or more of the figures herein, one or more boundaries, such as boundary 116 of FIG. 2, for example, are drawn with different heights, widths, perimeters, aspect ratios, shapes, etc. relative to one another merely for illustrative purposes, and are not necessarily drawn to scale. For example, because dashed or dotted lines are used to represent different boundaries, if the dashed and dotted lines were drawn on top of one another they would not be distinguishable in the figures, and thus are drawn with different dimensions or slightly apart from one another, in one or more of the figures, so that they are distinguishable from one another. As another example, where a boundary is associated with an irregular shape, the boundary, such as a box drawn with a dashed line, dotted lined, etc., does not necessarily encompass an entire component in one or more instances. Conversely, a drawn box does not necessarily encompass merely an associated component, in one or more instances, but can encompass a portion of one or more other components as well.

Graphic elements visually placed on environmental elements in the direct view of a driver by a vehicular HUD device are often called contact-analog or conformal augmented reality graphic elements. Successfully presenting contact-analog augmented reality graphic elements to the driver of a vehicle may depend on the ability of the vehicular HUD device to correctly reproduce depth cues. These depth cues can include accommodation and vergence. Accommodation is a depth cue where the muscles in the eye actively change the optical power to change focus at different distances. Vergence is the simultaneous or concurrent inward rotation of the eyes towards each other to maintain a single binocular image when viewing an object.

Although examples described herein may refer to a driver of a vehicle, graphic elements may be projected, provided, rendered, etc. within view of one or more other occupants of a vehicle, such as passengers, etc. To this end, these examples are not intended to be limiting, and are merely disclosed to illustrate one or more exemplary aspects of the instant application.

When a HUD device displays a graphic element on a windshield of a vehicle, accommodation may cause the human eye to shift between environmental elements and information displayed by the HUD device. Vergence causes the eyes to converge to points beyond the windshield into the environment, which may lead to the appearance of a double image of the HUD graphic element displayed on the windshield. Accordingly, to render contact-analog augmented reality graphic elements with correctly reproduced depth cues, graphic elements should be rendered on the same space as the real environment (e.g., at corresponding focal planes), rather than on the windshield of the vehicle.

A vehicle heads-up display device for displaying graphic elements in view of a driver of a vehicle while the driver views an environment through a windshield is provided. The heads-up display device can include one or more projectors that project a graphic element on a frontal focal plane in view of the driver while the driver views the environment through the windshield, and one or more projectors that project a graphic element on a ground-parallel focal plane in view of the driver while the driver views the environment through the windshield. The projector that projects the graphic element on the frontal focal plane may be mounted on an actuator that linearly moves the projector to cause the frontal focal plane to move in a direction of a line-of-sight of the driver. The projector that projects the ground-parallel focal plane may be fixedly arranged such that the ground-parallel focal plane is static.

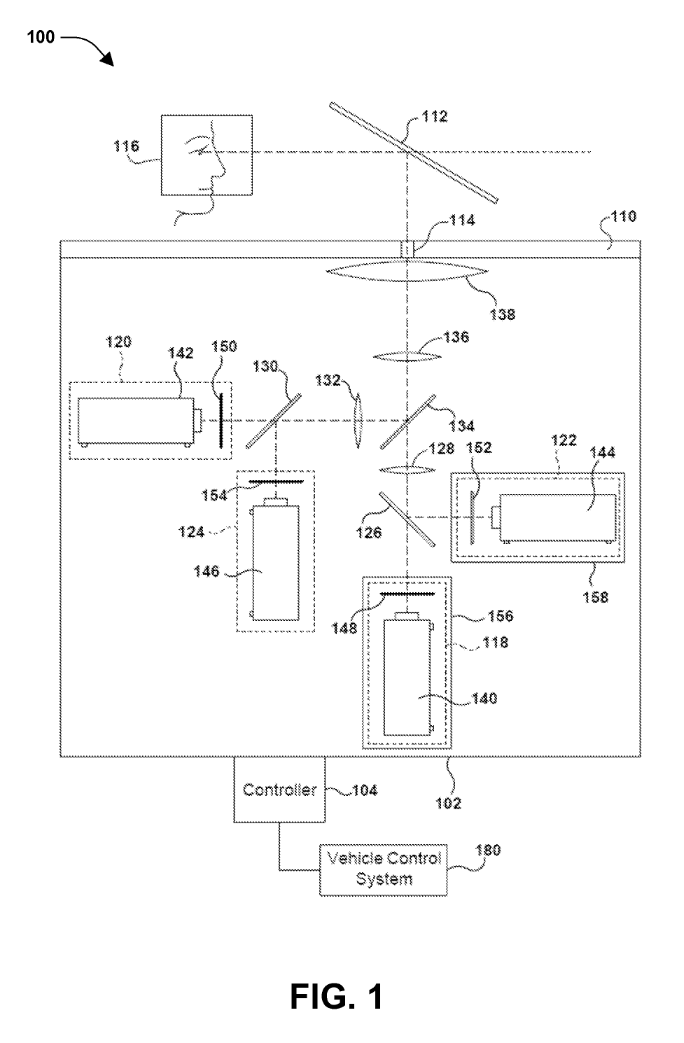

Referring to FIG. 1, a vehicular volumetric heads-up display system 100 (“HUD system 100”) or (“HUD component 100”) capable of rendering volumetric contact-analog augmented reality graphic elements (e.g., 3-dimensional or “3-D” graphic elements rendered into the same space as the real environment) with correctly reproduced depth cues is illustrated. The HUD system 100 includes a vehicle heads-up display device 102 (“HUD device 102”) and a controller 104 (or “controller component 104”). Referring to FIG. 2, the HUD system 100 may be provided in a vehicle 106, which includes a driver seat 108, a dashboard enclosure 110, and a windshield 112.

The configuration of the vehicle 106, with respect to the relative positioning of the driver seat 108, dashboard enclosure 110, and windshield 112, for example, may be conventional. To accommodate the herein-described HUD system 100, the dashboard enclosure 110 defines a housing space in which the HUD system 100 is housed. Further, the dashboard enclosure 110 has a HUD exit aperture 114 defined through an upper surface thereof. The HUD system 100 housed in the dashboard enclosure 110 projects graphic elements, such as contact-analog augmented reality graphic elements, through the HUD exit aperture 114 to the windshield 112, which may be used as a display screen for the HUD system 100. As described in further detail below, the augmented reality graphic elements can be rendered to the driver as if in the same space as the real environment.

A driver of the vehicle 106 drives the vehicle 106 while seated in the driver seat 108. Accordingly, the driver may be positionally constrained to a seating position on the driver seat 108 within the vehicle 106. In view of this positional constraint, the HUD system 100 may be designed using an assumption that the driver's view originates from an eye box 116 within the vehicle. The eye box 116 may be considered to include a region of an interior of the vehicle 106 where the driver's eyes are situated while the driver is seated in the driver seat 108.

The eye box 116 may be sized to encompass all possible head positions of the driver regardless of a position and posture of the driver seat 108, or the HUD system 100 may be configured to detect the position and posture of the driver seat 108, and to adjust a position and size of the eye box 116 based thereon. In one or more embodiments, the HUD system 100 may be designed assuming the eye box 116 has a fixed size and is in a fixed position. For example, the eye box may have the following dimensions: 20 cm×10 cm×10 cm. In any event, the HUD system 100 can be configured to present the contact-analog augmented reality graphic elements to the driver when the driver's eyes are within the eye box 116 and the driver is facing/looking in a forward direction through the windshield 112 of the vehicle 106. Although the eye box 116 of FIG. 2 is illustrated for the driver of the vehicle 106, the eye box 116 may be setup to include one or more other occupants of the vehicle. In one or more embodiments, one or more additional eye boxes or HUD devices may be provided for passengers or other occupants, for example.

The HUD device 102 displays one or more graphic elements in view of the driver of the vehicle 106 while the driver views an environment through the windshield 112 of the vehicle 106. Any graphic or environmental elements viewed by the driver through the windshield 112 while the driver's eyes are in the eye box 116 and the driver is facing/looking in the forward direction through the windshield 112 may be considered to be in view of the driver. As used herein, the view of the driver of the vehicle 106 while the driver views an environment through the windshield 112 of the vehicle 106 is intended to include an area viewed through the windshield 112, excluding dashboard displays located within the vehicle 106. In other words, the HUD device 102 presents the graphic elements such that the driver may view the graphic elements without looking away from the road.

Returning to FIG. 1, the HUD device 102 of the HUD system 100 includes a first projector 118, a second projector 120, a third projector 122, and a fourth projector 124. The first projector 118 and the third projector 122 share a first beam splitter 126 and a first objective lens 128, while the second projector 120 and fourth projector 124 share a second beam splitter 130 and a second objective lens 132. Consequently, the output of the first projector 118 and the third projector 122 can be received in the first beam splitter 126 and combined into a singular output, which is directed to (and through) the first objective lens 128. Similarly, the output of the second projector 120 and the fourth projector 124 can be received in the second beam splitter 130 and combined into a singular output, which is directed to (and through) the second objective lens 132.

The HUD device 102 further includes a third beam splitter 134 disposed downstream from the first and second objective lenses 128, 132 configured to receive the output from the first and second objective lenses 128, 132. The outputs from the first and second objective lenses 128, 132 can be combined at the third beam splitter 134 into a singular output, which can be a combination of the output of all of the first, second, third, and fourth projectors 118, 120, 122, 124, and directed to (and through) a third objective lens 136 and an ocular lens 138 before being directed out of the HUD exit aperture 114 to the windshield 112, which may be used as the display screen for the HUD system 100.

Each of the first projector 118, the second projector 120, the third projector 122, and the fourth projector 124 include a projector unit 140, 142, 144, 146 and a diffuser screen 148, 150, 152, 154 rigidly fixed a set distance from the projector unit 140, 142, 144, 146 and arranged relative to the projector unit 140, 142, 144, 146 such that light emitted from the projector unit 140, 142, 144, 146 passes through the diffuser screen 148, 150, 152, 154. The projector units 140, 142, 144, 146 can be light-emitting units which project an image or graphic element that passes through the associated diffuser screen 148, 150, 152, 154. The diffuser screens 148, 150, 152, 154 serve as a luminous image source (or object) for the rest of the optical system of the HUD device 102, and ensure that much of the light leaving the diffuser screens 148, 150, 152, 154 falls into the optics following the diffuser screens 148, 150, 152, 154 (e.g., the first beam splitter 126, the first objective lens 128, the second beam splitter 130, the second objective lens 132, the third beam splitter 134, the third objective lens 136, and the ocular lens 138), while spreading out light so that it eventually fills out the eye-box 116 so that brightness of the image or graphic element(s) stays constant while the driver's head moves within the eye box 116. Accordingly, use of the diffuser screens 148, 150, 152, 154 substantially prevents different parts of the image or graphic element(s) from being visible from different points within the eye box 116, and thereby substantially prevents the occurrence of different visual behavior with slight head movement.

The projector units 140, 142, 144, 146 may take the form of any light-emitting unit suitable for the herein-described use. The projector units 140, 142, 144, 146 may take the form of any light-emitting unit capable of projecting an image or graphic element according to the herein-described use(s). Similarly, the diffuser screens 148, 150, 152, 154 may take the form of any light diffusing screen suitable for the herein-described use(s).

The first projector 118 can be mounted on a first actuator 156 in the HUD device 102. The first actuator 156 can be a linear actuator capable of moving the first projector 118 in a linear direction toward and away from the first beam splitter 126. Additionally, the third projector 122 can be mounted on a second actuator 158 in the HUD device 102. The second actuator 158 can be a linear actuator capable of moving the third projector 122 in a linear direction toward and away from the first beam splitter 126. The first and second actuators 156, 158 may take the form of any linear actuators suitable for the herein-described use. The ability of the first projector 118 and the third projector 122 to linearly move allows the first projector 118 and the third projector 122 to project graphic elements on dynamic or movable focal planes. In contrast to the first and third projectors 118, 122, the second and fourth projectors 120, 124 can be fixedly arranged in the HUD device 102, and therefore project graphic elements on static focal planes.

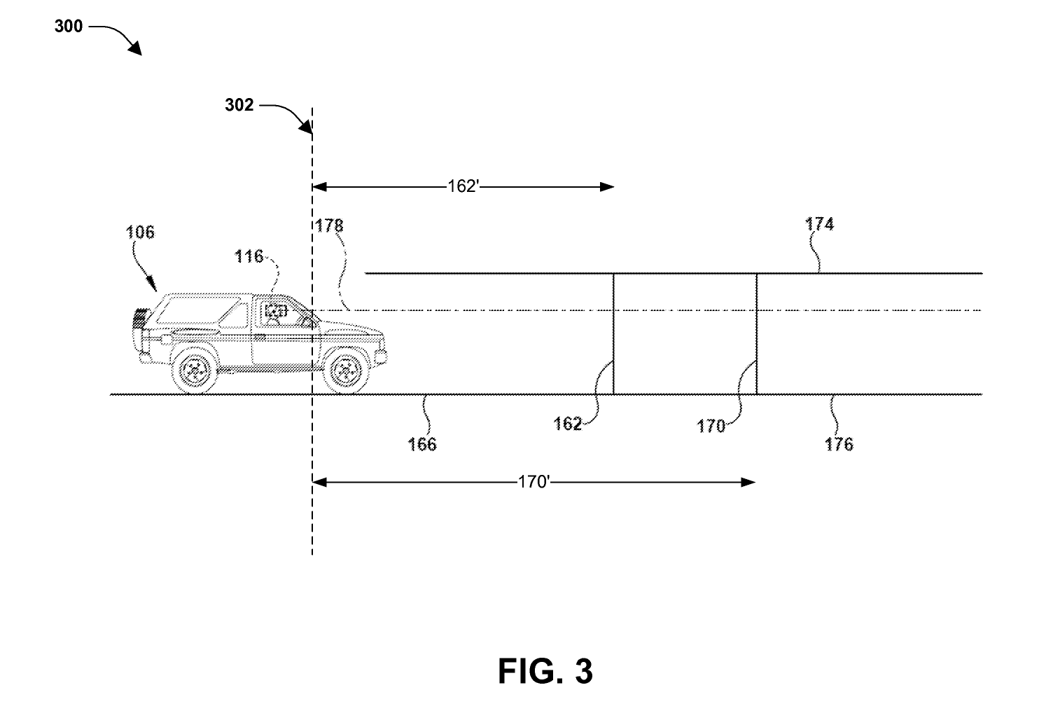

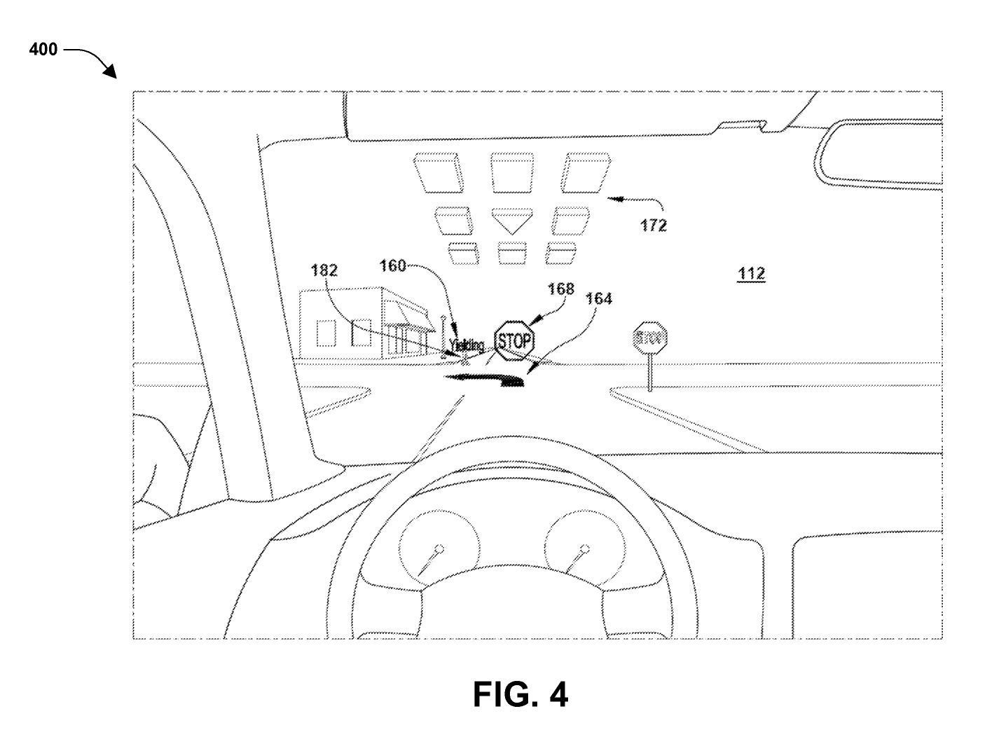

Using the first, second, third, and fourth projectors 118, 120, 122, 124, the HUD device 102 may render graphic elements (contact-analog augmented reality graphic elements or otherwise) in four distinct focal planes in the environment viewed by the driver through the windshield 112. In this regard, the first projector 118 can be configured to project a first graphic element 160 in a first focal plane 162, the second projector 120 can be configured to project a second graphic 164 element in a second focal plane 166, the third projector 122 can be configured to project a third graphic element 168 in a third focal plane 170, and the fourth projector 124 can be configured to project a fourth graphic element 172 in a fourth focal plane 174 (as will be described with reference to FIGS. 3 and 4). All of the first, second, third, and fourth graphic elements 160, 164, 168, 172, and their associated first, second, third, and fourth focal planes 162, 166, 170, 174, can be rendered in the environment in view of the driver as the driver is driving the vehicle 106 and the driver's eyes are in the eye box 116 while the driver is looking in a forward direction through the windshield 112.

Referring to FIG. 3 and FIG. 4, the projection of the first, second, third, and fourth graphic elements 160, 164, 168, 172 on the first, second, third, and fourth focal planes 162, 166, 170, 174 will be described with reference to a ground surface 176 and a line-of-sight 178 of the driver. In this regard, the ground surface 176 is a surface of a road in front of the vehicle 106. For the purposes of the instant description, the ground surface 176 will be assumed to be a substantially planar surface. The line-of-sight 178 of the driver is a line extending substantially parallel to the ground surface 176 from the eye box 116 in the forward direction. As used herein, a direction of the line-of-sight 178 is a direction extending toward and away from the driver and the vehicle 106 along the line-of-sight 178.

The first focal plane 162 is a frontal focal plane which may be oriented substantially perpendicularly to the line-of-sight 178 of the driver. The third focal plane 170 is also a frontal focal plane which may be oriented substantially perpendicularly to the line-of-sight 178 of the driver. The first and third focal planes 162, 170 can be dynamic focal planes which are movable in the direction of the line-of-sight 178, both in the forward direction (away from the vehicle 106) and in a rearward direction (toward the vehicle 106). The second focal plane 166 is a ground-parallel focal plane which may be oriented substantially parallel to the ground surface 176, and may be disposed on the ground surface 176 such that the second focal plane 166 is a ground focal plane. The fourth focal plane 174 is also a ground-parallel focal plane which may be oriented substantially parallel to the ground surface 176, and is disposed above the ground surface 176. The fourth focal plane 174 may be disposed above the ground surface 176 and the line-of-sight 178 of the driver to be a sky or ceiling focal plane. As a result, the second and fourth focal planes 166, 174 may be static focal planes.

Referring to FIG. 4, the first, second, third, and fourth graphic elements 160, 164, 168, 172 may be used to present different information to the driver. The exact type of information displayed by the first, second, third, and fourth graphic elements 160, 164, 168, 172 may vary. For exemplary purposes, the first graphic element 160 and third graphic element 168 may present a warning to the driver instructing the driver to yield to a hazard or obstacle, or may present a navigation instruction or driving instruction associated with rules of the road (e.g., a STOP sign, a YIELD sign, etc.). The second graphic element 164 and fourth graphic element 172 may present navigation instructions to the driver as a graphic overlay presented on the ground surface 176, or may present a vehicle-surrounding indicator to the driver. The first, second, third, and fourth graphic elements 160, 164, 168, 172 may present information or graphic elements to the driver which are different than those described herein, and that a subset of the first, second, third, and fourth graphic elements 160, 164, 168, 172 may be presented.

Returning to FIG. 1, the controller 104 may include one or more computers, (e.g., arithmetic) processors, or any other devices capable of communicating with one or more vehicle control systems 180 and controlling the HUD device 102. One or more of the vehicle control systems 180 (herein, “vehicle control system 180” or “vehicle control component 180”) may take the form(s) of any vehicle control system 180 used to actively or passively facilitate control of the vehicle 106. The vehicle control system 180 may include or communicate with one or more sensors (not shown) which detect driving and environmental conditions related to the operation of the vehicle 106.

With general reference to the operation of the HUD system 100, the controller 104 communicates with the vehicle control system 180, and based on the communication with the vehicle control system 180, determines the type and position of graphic elements to be presented to the driver of the vehicle 106. The controller 104 determines the type of graphic element to be presented as the first, second, third, and fourth graphic elements 160, 164, 168, 172 by the first, second, third, and fourth projectors 118, 120, 122, 124, and controls the first, second, third, and fourth projectors 118, 120, 122, 124 to project the first, second, third, and fourth graphic elements 160, 164, 168, 172 as the determined graphic elements. The controller 104 can determine a target first graphic element position and a target third graphic element position as target positions at which the first and third graphic elements 160, 168 should be rendered in the environment to the driver. The controller 104 then controls the first and second actuators 156, 158 to linearly move the first and third projectors 118, 122 such that the first and third focal planes 162, 170 can be moved to the target first and third graphic element positions, respectively.

Accordingly, the first projector 118 projects the first graphic element 160 on the first focal plane 162, which may be oriented substantially perpendicularly to the line-of-sight of the driver, and can be movable toward and away from the vehicle 106 in the direction of the line-of-sight 178 of the driver through linear movement of the first projector 118 by the first actuator 156. The second projector 120 projects the second graphic element 164 on the second focal plane 166, which is static and oriented parallel to the ground surface 176 and disposed on the ground surface 176. The third projector 122 projects the third graphic element 168 on the third focal plane 170, which may be oriented substantially perpendicularly to the line-of-sight of the driver, and be movable or adjustable toward and away from the vehicle 106 in the direction of the line-of-sight 178 of the driver through linear movement of the third projector 122 by the second actuator 158. The fourth projector 124 projects the fourth graphic element 172 on the fourth focal plane 174, which is static, oriented parallel to the ground surface 176, and can be disposed above the line-of-sight 178 of the driver. The controller 104 controls the first and second actuators 156, 158 to move the first and third projectors 118, 122 to move the first and third focal planes 162, 170.

By having the first and third projectors 118, 122 project the first and third graphic elements 160, 168 on the movable first and third focal planes 162, 170 which are oriented substantially perpendicular to the line-of-sight 178 of the driver, focus of objects at different distances from the vehicle 106 may be adjusted. This may facilitate the provision of correct depth cues to the driver for the first and third graphic elements 160, 168, especially since the HUD system 100 may be a vehicular application, with the vehicle 106 serving as a moving platform.

While the second and fourth projectors 120, 124 project the second and fourth graphic elements 164, 172 on the static second and fourth focal planes 166, 174, the second and fourth focal planes 166, 174 may be continuous. To make the second and fourth focal planes 166, 174 parallel to the ground surface 176, the diffuser screens 150, 154 of the second and fourth projectors 120, 124 may be tilted. Since the optical system of the HUD device 102 has very low distortion and is nearly telocentric for images in a ground-parallel focal plane, light rays are close to parallel with the optical axis, which allows the projected second and fourth graphic elements 164, 172 to be projected or rendered without distorting or changing the magnification while the second and fourth focal planes 166, 174 are tilted. The resulting second and fourth graphic elements 164, 172 therefore appear on a continuous focal plane (the second and fourth focal planes 166, 174) parallel to the ground surface 176. In this regard, the second and fourth graphic elements 164, 172 may be rendered with an actual 3-dimensional (3-D) volumetric shape, instead of as line segments, to add monocular cues to strengthen depth perception.

The continuous, static second and fourth focal planes 166, 174 facilitate driver depth perception with regard to the second and fourth graphic elements 164, 172. The continuous, static second and fourth focal planes 166, 174 allow for correct generation of real images or graphic elements through the forward-rearward direction in 3-D space (e.g., the direction of the line-of-sight 178 of the driver), allowing proper motion parallax cues to be generated. Accordingly, as the driver's head shifts from side-to-side or up-and-down, the second and fourth graphic elements 164, 172 appear to the driver to be fixed in position in the environment, rather than moving around. Consequently, the HUD system 100 does not need a head-tracking function to compensate for movement of the driver's head.

With regard to the previously-listed exemplary information which may be presented to the driver, the vehicle control system 180 may include processing and sensors capable of performing the following functions: hazard or obstacle detection; navigation; navigation instruction; and vehicle surrounding (e.g., blind-spot) monitoring. The vehicle control system 180 may include processing and sensors capable of performing other vehicle control functions (e.g., highway merge assist, etc.), which may alternatively or additionally be tied to information presented to the driver using the HUD system 100. Regardless of the functions performed by the vehicle control system 180, the precise manner of operation of the vehicle control system 180 to perform the functions, including the associated sensors and processing, may not be relevant to the operation of the HUD system 100.

The controller 104 communicates with the vehicle control system 180, and receives therefrom inputs related to the operation of the vehicle 106 and associated with the above-listed (or other) functions. The controller 104 then controls the HUD device 102 based on the inputs received from the vehicle control system 180. In this regard, one or both of the controller 104 and the vehicle control system 180 may determine: the type of graphic element to be displayed as the first, second, third, and fourth graphic elements 160, 164, 168, 172; the location of the first, second, third, and fourth graphic elements 160, 164, 168, 172; and which of the first, second, third, and fourth graphic elements 160, 164, 168, 172 are to be displayed. These determinations may be based on one or more vehicle functions employed by the driver, such as whether the driver is using the navigation function.

Regardless of which of the controller 104 or the vehicle control system 180 are used to make these determinations, the controller 104 controls the HUD device 102 to display the appropriate graphic elements at the appropriate locations. This can include controlling the first, second, third, and fourth projectors 118, 120, 122, 124 to project the appropriate first, second, third, and fourth graphic elements 160, 164, 168, 172. This can include controlling the first and second actuators 156, 158 to linearly move the first and third projectors 118, 122, to move the first and third focal planes 162, 170 to the appropriate (e.g., target) positions. For example, one or more actuators, such as 156, 158, may be configured to move one or more of the focal planes, such as 162, 170. For example, with reference to the third focal plane 170, a distance between the third focal plane 170 and a windshield of the vehicle 106 (e.g., at 302) may be adjusted by adjusting distance 170′. Similarly, distance 162′ may be adjusted to change a target position for focal plane 162.

In view of the previously-listed exemplary information associated with the first, second, third, and fourth graphic elements 160, 164, 168, 172, operation of the HUD system 100 will be described with reference to the vehicle 106 having the vehicle control system 180 which enables the following functions: a hazard or obstacle detection and warning function; a navigation function; a navigation instruction function; and a vehicle surrounding (e.g., blind-spot) monitoring function. Again, the vehicle 106 may have a subset of these functions or additional functions, and that the HUD system 100 may be employed with reference to the subset or additional functions. The description of the HUD system 100 with reference to these functions is merely exemplary, and are used to facilitate description of the HUD system 100. Though one of or both of the controller 104 and the vehicle control system 180 may make determinations associated with the operation of the HUD system 100, in the below description, the controller 104 is described as being configured to make determinations based on input received from the vehicle control system 180.

Information related to the obstacle detection and warning function may be presented to the driver as a contact-analog augmented reality graphic element projected by the first projector 118 of the HUD device 102. In this regard, the vehicle control system 180 may detect various obstacles in the roadway on which the vehicle 106 is travelling. For example, obstacles may include pedestrians crossing the roadway, other vehicles, animals, debris in the roadway, potholes, etc. The detection of these obstacles may be made by processing information from the environment sensed by sensors (not shown) provided on the vehicle 106. Further, obstacle detection may be carried out in any manner.

When an obstacle is detected, the vehicle control system 180 communicates obstacle information to the controller 104. The controller 104 receives the obstacle information from the vehicle control system 180 and determines the type of graphic element to present as the first graphic element 160 and the target first graphic element position based on the received obstacle information. While various types of graphic elements may be used, such as flashing icons, other signs, etc., examples herein will be described with reference to a “YIELD” sign presented when an obstacle is detected.

Referring to FIG. 4, the obstacle detected by the vehicle control system 180 may be a pedestrian 182 crossing the road on which the vehicle 106 is travelling. In the exemplary view of the driver of FIG. 4, the vehicle 106 is traveling on a road which is being crossed by the pedestrian 182. Accordingly, the vehicle control system 180 can send obstacle information related to the pedestrian 182 to the controller 104. Based on the obstacle information, the controller 104 can determine the type of graphic element to be displayed as the first graphic element 160; in this case, for example, the graphic element can be a “YIELD” sign, although other graphic may be used. The controller 104 can determine the target first graphic element position such that the first graphic element 160 will be projected and rendered to be perceived by the driver to be at a same depth (e.g., focal plane) as the pedestrian 182. Further, the controller 104 can be configured to adjust the target first graphic element position such that the first graphic element 160 ‘tracks’ or ‘follows’ the pedestrian 182, as the pedestrian 182 walks, for example.

The controller 104 then controls the first projector 118 to project the “YIELD” sign as the first graphic element 160, and controls the first actuator 156 to linearly move the first projector 118 such that the first graphic element 160 can be projected and rendered to be perceived by the driver (e.g., while the driver's eyes are in the eye box 116 and the driver is looking in the forward direction through the windshield 112) to be at the same depth as the pedestrian 182. The first actuator 156 can be controlled such that the first graphic element 160 can be projected on the first focal plane 162, which can be positioned at the target first graphic element position and may be oriented substantially perpendicular to the line-of-sight 178.

As the vehicle 106 and the pedestrian 182 travel on the road, the relative distance between the two will change. This change in distance may be communicated to the controller 104 by the vehicle control system 180, the target first graphic element position may be changed accordingly, and the first actuator 156 may be controlled by the controller 104 to move the first focal plane 162 to remain at the (e.g., changed/changing) target first graphic element position. Accordingly, projecting the first graphic element 160 on the first focal plane 162 which may be movable in the direction of the line-of-sight 178 of the driver, the depth cues associated with the first graphic element 160 can be correctly reproduced so that the driver may accurately judge the position of the first graphic element 160 (e.g., the detected obstacle).

Additionally, information related to the navigation function may be presented to the driver as a contact-analog augmented reality graphic element projected by the second projector 120 of the HUD device 102. In this regard, the vehicle control system 180 may, upon receiving a navigation request from the driver (e.g., the input of a desired location), generate a navigation route for the driver to follow to get to the desired location. The navigation route includes a set of driving directions for the driver to follow, including instructions to turn onto streets on the route to the desired location. The navigation function may be carried out in any manner. When the navigation function is activated, the vehicle control system 180 can communicate the driving directions associated with the navigation function to the controller 104.

The controller 104 can receive the driving directions from the vehicle control system 180 and determine the type of graphic element to present as the second graphic element 164. The types of graphic elements associated with the navigation function may include graphic elements which instruct the driver to continue on the current road (e.g., a straight line or arrow), to turn left or right onto an upcoming cross-road (e.g., a left/right arrow or line turning in the appropriate direction), to enter, merge onto, or exit from a highway (e.g., a line or arrow indicating the appropriate path), etc. The controller 104 selects the appropriate graphic element to present as the second graphic element 164 based on the driving direction communicated from the vehicle control system 180.

Referring to the exemplary view of the driver of FIG. 4, the driving direction for the driving route determined by the navigation function of the vehicle control system 180 includes a left-hand turn onto an upcoming street. Accordingly, the controller 104 controls the second projector 120 to generate and project a left-hand turn graphic element as the second graphic element 164 on the second focal plane 166. As shown in FIG. 4, the second focal plane 166 may be oriented parallel to the ground surface 176 and be disposed on the ground surface 176. As noted above, the second projector 120 can be fixedly arranged in the HUD device 102, such that the second focal plane 166 is static. As noted above, the second focal plane 166 may be continuous, such that the second graphic element 164 can be rendered to the driver with appropriate depth cues as a 3-D image.

Similarly, information related to the navigation instruction function may be presented to the driver as a contact-analog augmented reality graphic element projected by the third projector 122 of the HUD device 102. In this regard, the vehicle control system 180 may use sensors or information stored in a database and associated with a map to monitor the road on which the vehicle 106 is traveling, and to determine upcoming navigation instructions associated with travel on that road. For example, the vehicle control system 180 may detect an upcoming required stop, yield, or other condition (herein, collectively referenced as “road condition”) on the road on which the vehicle 106 is traveling. The vehicle control system 180 may determine a navigation instruction associated with the detected road condition (e.g., a stop instruction associated with a stop road condition, etc.). The navigation instruction function may be carried out in any manner, the specifics of which are not necessarily relevant to the operation of the HUD system 100. Additionally, road conditions can include, among other things, traffic on a road segment, obstructions, obstacles, weather conditions, conditions of a surface of a road segment, speed limits associated with a portion of a road or road segment, etc. In other words, road conditions can generally include reasons to speed up, slow down, take a detour, stop, exercise caution, etc. while driving, for example.

The vehicle control system 180 communicates the road condition or the navigation instructions associated with the road condition, as well as information related to a position of the road condition, to the controller 104. The controller 104 can control the third projector 122 to project the third graphic element 168 to communicate information to the driver related to the road condition or associated navigation instruction accordingly. The controller 104 can receive the road condition or navigation instruction information, as well as the position information, from the vehicle control system 180, and determine the type of graphic element to present as the third graphic element 168 and a target third graphic element position.

Various types of graphic elements may be used in conjunction with navigation instruction functions, for example: a STOP sign, a YIELD sign, a ONE WAY sign, a NO TURN ON RED sign, etc. The type of graphic element may be selected to communicate the navigation instruction associated with the road condition. Whichever type of graphic element the controller 104 determines should be used as the third graphic element 168, that graphic element may be projected to appear at the location of the driving condition. In this regard, the target third graphic element position may be determined as a position at which the third graphic element 168 should be rendered in view of the driver based on the position of the detected road condition relative to the vehicle 106.

The controller 104 may be configured to control the third projector 122 to project the appropriate graphic element as the third graphic element 168. The controller can control the second actuator 158 to linearly move the third projector 122 such that the third graphic element 168 is projected and rendered to be perceived by the driver (e.g., while the driver's eyes are in the eye box 116 and the driver is looking in the forward direction through the windshield 112) to be at the same depth (e.g., having a same focal plane) as the road condition. The second actuator 158 can be controlled such that the third graphic element 168 is projected on the third focal plane 170, which can be positioned at the target third graphic element position and oriented substantially perpendicularly to the line-of-sight 178. The controller 104 may control the second actuator 158 to continuously linearly move the third projector 122 such that the third focal plane 170 moves as a distance between the vehicle 106 and the detected road condition (e.g., the target third graphic element position) changes (as detected by the vehicle control system 180 and communicated to the controller 104), for example, as a result of the vehicle 106 driving toward the detected road condition.

In the exemplary view of from the perspective of the driver in FIG. 4, the vehicle 106 is approaching a four-way intersection at which the vehicle 106 should stop. Accordingly, the vehicle control system 180 detects the stop road condition at a position of an entrance of the intersection, and determines the navigation instruction associated with the stop road condition to be a stop instruction. The stop road condition or instruction, as well as the position of the stop road condition, can be communicated to the controller 104, which determines that a STOP sign should be presented as the third graphic element 168. The controller 104 can determine that the third graphic element 168 (e.g., the STOP sign) should appear at the position of the entrance of the four-way intersection. The position of the entrance of the intersection can therefore be determined to be the target third graphic element position.

The controller 104 can control the third projector 122 to project the “STOP” sign as the third graphic element 168, and control the second actuator 158 to move the third projector 122 such that the third graphic element 168 is projected and rendered to be perceived by the driver (e.g., while the driver's eyes are in the eye box 116 and the driver is looking in the forward direction through the windshield 112) to be at the same depth as the entrance of the four-way intersection. The second actuator 158 can be controlled such that the third graphic element 168 can be projected on the third focal plane 170, which is positioned at the target third graphic element position and oriented substantially perpendicularly to the line-of-sight 178. As the vehicle 106 travels on road, the relative distance between the vehicle 106 and the entrance of the four-way intersection will change. This change in distance may be communicated to the controller 104 by the vehicle control system 180, the target third graphic element position may be changed accordingly, and the second actuator 158 may be controlled by the controller 104 to move the third focal plane 170 to remain at the (e.g., changed/changing) target third graphic element position. Accordingly, projecting the third graphic element 168 on the third focal plane 170 which can be movable in the direction of the line-of-sight 178 of the driver, the depth cues associated with the third graphic element 168 may thus be correctly reproduced so that the driver may accurately judge the position of the third graphic element 168 (e.g., the detected road condition).

Information related to the vehicle surrounding (e.g., blind-spot) monitoring function may be presented to the driver by the fourth projector 124 of the HUD device 102. In this regard, the vehicle control system 180 may detect the existence of other vehicles in an area immediately surrounding or surrounding the vehicle 106. The detection of the other vehicles immediately surrounding the vehicle 106 may be made by processing information regarding the surroundings of the vehicle 106 sensed by sensors (not shown) provided on the vehicle 106. The vehicle surrounding determination may be carried out in any manner.

The vehicle surrounding information can be determined by the vehicle control system 180 and communicated to the controller 104. The controller 104 receives the vehicle surrounding information from the vehicle control system 180 and determines how, if at all, to modify the fourth graphic element 172 projected on the fourth focal plane 174. In this regard, the graphic element used as the fourth graphic element 172 to facilitate the vehicle surrounding (e.g., blind-spot) monitoring function may be a vehicle surrounding indicator, shown in FIG. 4.

The vehicle surrounding indicator includes a central marker representing the vehicle 106 and eight surrounding markers representing positions immediately surrounding the vehicle 106. The vehicle control system 180 communicates information about the positions of vehicles in the immediate surroundings of the vehicle 106, and the controller 104 controls the fourth projector 124 to change the fourth graphic element 172 such that one or more of the eight associated surrounding markers are highlighted. The highlighting of the eight surrounding markers indicates to the driver the position of other vehicles in the immediate surroundings of the vehicle 106.

In FIG. 4, the fourth graphic element 172 can be projected on the fourth focal plane 174, which may be oriented parallel to the ground surface 176 and can be disposed above the ground surface 176 and the line-of-sight 178. As noted above, the fourth projector 124 can be fixedly arranged in the HUD device 102, such that the fourth focal plane 174 is static. As noted above, the fourth focal plane 174 can be continuous, such that the fourth graphic element 172 may be rendered to the driver with appropriate depth cues as a 3-D image.

The fourth graphic element 172 may be presented in a form different than the vehicle surrounding indicator of FIG. 4. In any event, the fourth graphic element 172 can be projected onto the fourth focal plane 174, which may be oriented parallel to the ground surface 176 and can be disposed above the ground surface 176 and the line-of-sight 178 of the driver. Accordingly, the fourth graphic element 172 can be provided on the sky focal plane, which may be appropriate since the information communicated by the fourth graphic element 172 need not interact with the environment.

The above-described HUD system 100 can project graphic elements, some of which as contact-analog augmented reality graphic elements, at continuously changing focal distances as well as in ground-parallel focal planes with continuous changing focus from front-to-back in the direction of the line-of-sight 178 of the driver. Accordingly, depth perception cues may be improved, to facilitate focus and increase the attention the driver pays to the environment while simultaneously or concurrently (or near-simultaneously). This enables the driver to observe information presented via the graphic elements as well as the environment. In this regard, through experimentation, the inventors have determined that spatial perception may be greatly influenced by focal cues, and that the focal plane adjusting capability, as well as the capability to show graphic elements on continuous, static ground-parallel focal planes, of the herein-described HUD system 100 improves spatial perception. To this end, a greater improvement in spatial perception is observed when adjusting the focal cues as described herein, than is observed when adjusting a size of a graphic element.

The configuration of the HUD device 102, including the use of the beam splitters 126, 130, 134 and lenses 128, 132, 136, 138, allows the HUD device 102 to have a relatively compact size. Further, the lenses 128, 132, 136, 138 allow a range of depth to expand from a few meters in front of the vehicle 106 to infinity within the physical space allocated for the optics of the HUD device 102. Further still, the beam splitters 126, 130, 134 can be used as optical combiners to merge all of the disparate sets of projected rays from the first, second, third, and fourth projectors 118, 120, 122, 124 through the lenses 128, 132, 136, 138 to combine separate images from the first, second, third, and fourth projectors 118, 120, 122, 124 into one unified image (e.g., or graphic element) projected in view of the driver.

In one or more embodiments, several of the above-disclosed and other features and functions, or alternatives or varieties thereof, may be desirably combined into many other different systems or applications. Additionally, various presently unforeseen or unanticipated alternatives, modifications, variations, or improvements therein may be subsequently made by those skilled in the art which are also intended to be encompassed by the following claims.

For example, fewer or more projectors may be used in the HUD system 100 to project fewer or more graphic elements. Further, while the HUD system 100 is described as having two projectors which project graphic elements in frontal focal planes and two projectors which project graphic elements in ground-parallel focal planes, the proportion of frontal and ground-parallel focal planes may be changed. The above-described vehicle functions associated with the HUD system 100 are exemplary, and may be changed or modified.

Further still, the mechanism by which the frontal focal planes are moved may be modified from that described above. For example, rather than moving the entire projector (e.g., the first and third projectors 118, 122 using the first and second actuators 156, 158), merely the diffuser screens (e.g., the diffuser screens 148, 152 of the first and third projectors 118, 122) may be moved relative to the respective projector units (e.g., the projector units 140, 144).

Additionally, while the HUD system 100 has been described with reference to the vehicle 106, which may be a four-wheeled automobile for outdoor use, the HUD system 100 may be used in different types of vehicles. For example, the HUD system may be provided in a marine vehicle (e.g., a boat), an air vehicle (e.g., an airplane or jet), or a vehicle intended for indoor use (e.g., a transportation cart, a vehicle used for material handling, such as a forklift, etc.).

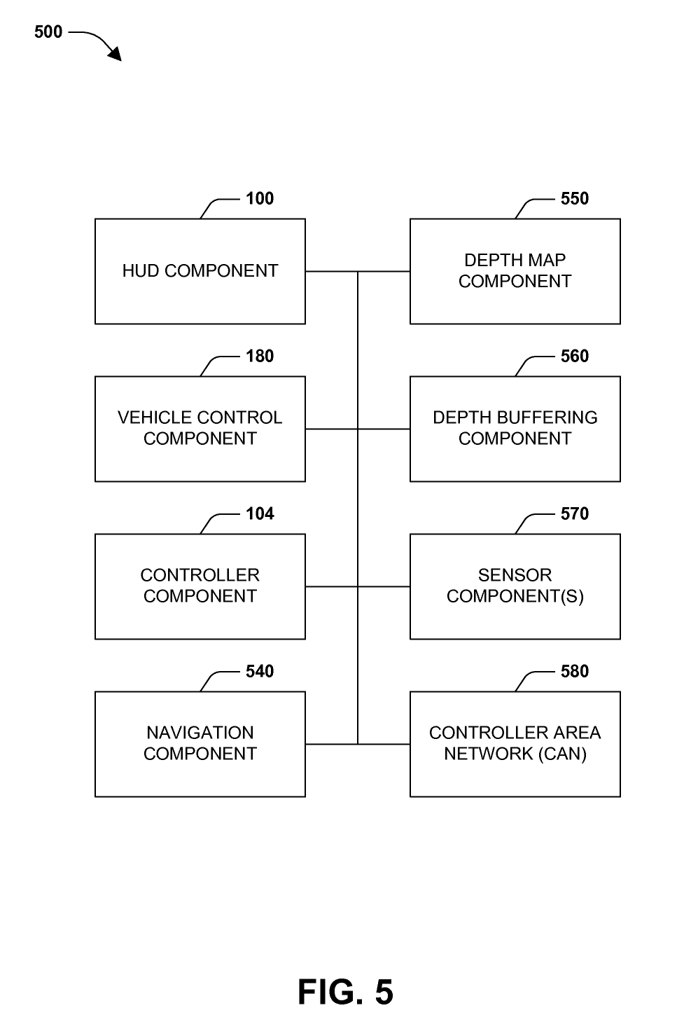

FIG. 5 is an illustration of an example component diagram of a system 500 for 3-D navigation, according to one or more embodiments. The system 500 can include a HUD component 100, a vehicle control component 180, a controller component 104, a navigation component 540, a depth map component 550, a depth buffering component 560, one or more sensor components 570, and one or more controller area networks (CANs) 580. The HUD component 100 can be a vehicular volumetric HUD system, such as the HUD system 100 of FIG. 1 and can include components described above. In one or more embodiments, the HUD component 100 can be a 3-D HUD, a variable distance HUD, an augmented reality HUD (AR-HUD), etc., among other things.

The navigation component 540 can be configured to receive or identify an origin location (e.g., point A) and one or more destination locations (e.g., point B). The navigation component 540 can be configured to calculate or determine one or more routes from point A to point B, for example. Generally, the navigation component 540 is associated with a vehicle. For example, the navigation component 540 may be mounted on the vehicle, integrated with one or more systems or one or more components of the vehicle, housed within the vehicle, linked or communicatively coupled with one or more components of the vehicle, or located within the vehicle, etc. In any event, the navigation component 540 can identify or receive the origin location and the destination location. In one or more embodiments, the navigation component 540 can include a telematics component (not shown) that may be configured to determine a current location or current position of the vehicle.

Additionally, the navigation component 540 can be configured to generate one or more routes from the origin location to one or more of the destination locations. In one or more embodiments, the navigation component 540 can be configured to generate one or more of the routes from a current location or current position of the vehicle to one or more of the destination locations. A route of the one or more routes can include one or more portions or one or more route portions. As an example, one or more portions of the route may include one or more navigation instructions or maneuvers associated with one or more road segments or one or more intersections of road segments. In other words, one or more portions of the route may include one or more turns, navigation maneuvers, road segments, intersections, landmarks, or other elements along the route. The navigation component 540 may be configured to identify one or more of these turns, navigation maneuvers, landmarks, etc. and issue one or more navigation commands or one or more navigation instructions accordingly, such as to a driver of the vehicle.

The navigation component 540 may issue one or more of the navigation commands or navigation instructions via an audio prompt, visual prompt, tactile prompt, etc. For example, the navigation component 540 may interface with one or more peripheral components (not shown) by transmitting one or more prompts across one or more controller area networks (CANs) 580. The navigation component 540 may play back an audible instruction, such as, “Turn left at Main Street”, or flash a light on the left hand portion of a display, vibrate the steering wheel, etc. to indicate to a driver that a driving action should be taken. The navigation component 540 can interact with one or more other components to facilitate transmittal or delivery of one or more of the driving instructions.

For example, the HUD component 100 may be configured to project one or more navigation instructions or one or more navigation maneuvers as one or more graphic elements or avatars in view of an occupant or driver of the vehicle. These navigation instructions may be received (e.g., directly or indirectly) from the navigation component 540. The HUD component 100 can be configured to project an avatar on successive focal planes such that the avatar appears to be moving to an occupant, such as a driver having a view from eye box 116 of FIG. 2. In this way, the HUD component 100 can enable a driver to perceive a volumetric image in view of the driver, where the volumetric image can serve as a ‘virtual’ guide vehicle for the driver of the vehicle to follow. In other words, it may appear to the driver of the vehicle that he or she is merely following a guide vehicle to a destination location, for example. Additionally, one or more other navigation commands or navigation instructions may be projected as a volumetric placeholder, marker, or flagpole, as will be described herein.

The HUD component 100 can be configured to project one or more graphic elements, which may be contact analog augmented reality graphic elements, conformal augmented reality graphic elements, avatars, icons, etc. These graphic elements can be projected by the HUD component 100 in a volumetric manner. As a result of this, one or more visual cues or one or more depth cues associated with the graphic elements can be substantially preserved. Preservation of one or more of these visual cues or depth cues may be achieved by projecting or rendering graphic elements on a dynamic focal plane or a movable focal plane. That is, the HUD component 100 may be configured to project or render one or more graphic elements on a movable or adjustable focal plane. A dynamic focal plane or a movable focal plane can be moved or adjusted along a path or a line, such as a line of sight of an occupant of a vehicle, as discussed with reference to FIG. 1 and FIG. 3, for example. In other words, the dynamic focal plane can be movable towards a vehicle or a windshield of a vehicle or away therefrom.

In one or more embodiments, a focal plane may be dynamic as a result of movement of projectors or screens of the HUD component 100, such as through the use of actuators, for example. That is, one or more projectors of the HUD component 100 can be configured to move in a linear fashion, thereby enabling respective projectors to project one or more graphic elements on a dynamic, movable, or adjustable focal plane, which move when the projectors move. In other embodiments one or more other means or alternative means for adjustments may be utilized.

Explained another way, when a graphic element is projected on a dynamic, movable, or adjustable focal plane, the graphic element may be projected onto a focal plane wherein a distance (e.g., distance 162′ or distance 170′ of FIG. 3) from the focal plane and the vehicle is being adjusted. Because projectors of a HUD component 100 can project or render graphic elements on movable focal planes, the focus of graphic elements projected at various distances from the vehicle can be adjusted. As mentioned, one or more of the focal planes may be oriented substantially perpendicular or substantially parallel to a line or sight of an occupant of the vehicle. In other words, a focal plane can be ground parallel or ground perpendicular. Additionally, one or more of the focal planes can be movable or static with respect to the line of sight of the occupant or the ground. This enables depth cues associated with the graphic elements to be correctly presented to occupants of the vehicle, such as the driver, as the vehicle moves or travels (e.g., and thus serves as a moving platform).

The HUD component 100 of FIG. 5 can be configured to project or render volumetric contact-analog augmented reality graphic elements. This means that these graphic elements may be projected to appear at various distances. In other words, the HUD component 100 can project graphic elements at multiple focal planes or in an adjustable manner. Explained yet another way, focal planes of graphic elements projected by the HUD component 100 can be adjusted to distances which extend beyond the windshield, such as next to a pedestrian on the sidewalk, thereby enabling an occupant to focus on the operating environment or driving environment, rather than switching focus of their eyes between the windshield or instrument panel of the vehicle and the driving environment. In this way, safety may be promoted by the system 500 for 3-D navigation.

Accordingly, graphic elements may be projected or visually placed (e.g., by the HUD component 100) in an environment in direct view of an occupant. This means that graphic elements can be rendered in the same space as the real environment, rather than on the windshield, allowing depth cues associated with the graphic element to be reproduced in an accurate or correct manner. As a result, graphic elements can be projected on the same focal planes as real world objects (e.g., the road) such that an occupant of a vehicle may view the graphic elements without looking away from the road, for example.

These multiple focal planes or adjustable focal planes may be achieved because when projectors of a HUD component 100 are moved, light rays can be reshaped or altered such that a graphic element or virtual object being projected can appear to be further away than the windshield or have a focal plane that is not on the windshield. That is, the projected graphic element or virtual object can have similar focal properties as a real object (e.g., pedestrian, vehicle, sign, etc.) that is far away (e.g., ten meters), for example. As light rays are reflected off of glass from the windshield, outgoing light rays diverge, thereby creating a ‘reflected’ image or a real image, which can be projected as a graphic element.

Because the light rays are reflected off of the windshield, rather than being emitted or appearing from the windshield (e.g., as with special coatings), re-rendering of a graphic element is not necessary when an occupant moves his or her head. For example, the continuous, static focal planes of FIG. 3 enable optically ‘correct’ or real images to be generated through the forward-rearward direction in 3-dimensional space (e.g., the direction of the line-of-sight of an occupant), thereby allowing proper motion parallax cues to be generated. Accordingly, when the occupant's head shifts, graphic elements associated with these focal planes may appear to be fixed in position in the environment, rather than moving around. As mentioned, this means that the HUD component 100 does not require head-tracking functionality to compensate for movement of an occupant's head.

The HUD component 100 can be rastor based, rather than vector based. This means that graphic elements projected by the HUD component 100 can be a bitmap, have a dot matrix structure, or be a rectangular grid of pixels. Additionally, the HUD component 100 can be configured to project one or more portions of one or more graphic elements with different shading, transparency levels, colors, brightness, etc.

In this way, the HUD component 100 can be configured to render or project graphic elements or avatars with various degrees of freedom. That is, accommodation may be preserved such that the eyes of an occupant may actively change optical power to focus on a graphic element projected on a focal plane. Similarly, vergence may be preserved such that the occupant may have concurrent inward rotation of a graphic element as the graphic element is projected to move ‘closer’ (e.g., by projecting onto successively closer focal planes).

In one or more embodiments, the HUD component 100 can project a graphic element as an avatar or a moving avatar for a driver or occupant of a vehicle to follow as a navigation instruction, maneuver, or command. For example, the HUD component 100 can be configured to project or render one or more of the graphic elements are a moving avatar, placeholder, identifier, flag pole, marker, etc. These graphic elements may be projected on one or more focal planes around an environment surrounding the vehicle, and projected in view of an occupant of the vehicle. An avatar or graphic element projected by the HUD component 100 can lead a driver of a vehicle through one or more portions of a route, and mitigate collisions with obstacles, obstructions, or road conditions by being projected to weave, navigate, move, or travel around the obstacles. A sensor component 570 can be configured to sense one or more obstacles or road conditions and a controller component 104 can direct the HUD component 100 to project the graphic element such that the graphic element travels around or bypasses a road condition, such as by changing lanes to avoid a traffic barrel, for example.

In one or more embodiments, the sensor component 570 can be configured to sense, identify, or detect one or more road conditions in an environment around or surrounding the vehicle. The sensor component 570 can detect or identify road segments, sidewalks, objects, pedestrians, other vehicles, obstructions, obstacles, debris, potholes, road surface conditions (e.g., ice, rain, sand, gravel, etc.), traffic conditions, traffic signs (e.g., red lights, speed limit signs, stop signs, railroad crossings, trains, etc.). These road conditions can be transmitted to the controller component 104 or the vehicle control component 180. For example, one or more of the CANs 580 may be used to facilitate communication between the sensor component 570 and the controller component 104 or the vehicle control component 180. In one or more embodiments, the sensor component 570 can include one or more image capture devices, a microphone, blind spot monitor, parking sensor, proximity sensor, presence sensor, infrared sensor, motion sensor, etc.

The vehicle control component 180 can be configured to receive data associated with one or more of the road conditions or data related to an environment surrounding the vehicle (e.g., operating environment, driving environment, surrounding environment, etc.). In one or more embodiments, the vehicle control component 180 can receive one or more of the road conditions from the sensor component 570. Additionally, the vehicle control component 180 can receive one or more road conditions from one or more other sources, such as a server (not shown) or a database (not shown), for example. The vehicle control component 180 may be communicatively coupled with the server, third party, database, or other entity via a telematics channel initiated via a telematics component (not shown). In this way, the vehicle control component 180 can gather information associated with one or more portions of a route from an origin location to a destination location.

For example, the vehicle control component 180 may receive road condition information that includes traffic information of a road segment (e.g., whether traffic is congested, if there is an accident on the road, etc.). Additionally, the vehicle control component 180 may receive speed limit information associated with one or more of the road segments of a route. This information may be used to determine how to project one or more graphic elements to a driver or occupant of a vehicle. That is, if a road segment is associated with a 65 mph speed limit, and a current velocity (e.g., detected by the sensor component 570) of the vehicle is 25 mph, the vehicle control component 180 may command the HUD component 100 to project an avatar such that the avatar appears to speed up upon turning onto the road segment.

As another example, if the sensor component 570 detects a traffic barrel in a current lane in which the vehicle is travelling, the vehicle control component 180 can receive this information and make a determination that a navigation instruction to change lanes should be projected by the HUD component 100. This command may be transmitted over one or more CANs 580 to the HUD component 100, which can project, render, or animate an avatar or graphic element changing lanes or shifting position in response to the detected traffic barrel. In other words, the HUD component 100 may project an avatar or icon that appears to weave around or navigate around the traffic barrel, which is positioned in front of the vehicle in the operating environment surrounding the vehicle. As well, the vehicle control component 180 may be configured to have the HUD component 100 project a turn signal on the avatar, as a real vehicle might indicate when changing lanes. Further, the vehicle control component 180 may adjust a perceived velocity for the avatar as the avatar approaches the traffic barrel. This may be achieved by projecting the avatar or graphic element in successively closer focal planes or by adjusting a dynamic focal plane of the graphic element such that the distance between the dynamic focal plane and the vehicle or windshield of the vehicle is reduced. (Conversely, when it is desired to project the avatar as speeding up, the dynamic focal plane may be adjusted such that the distance between the dynamic focal plane and the vehicle or windshield thereof is increased).

In other words, the vehicle control component 180 can be configured to receive one or more road conditions, wherein a road condition of the one or more road conditions comprises traffic information of one or more of the road segments or speed limit information associated with one or more of the road segments. Further, the vehicle control component 180 can be configured to drive the HUD component 100 to project one or more graphic elements based on one or more of the road conditions, such as a speed limit of a road segment, and a current velocity of the vehicle. In this way, the vehicle control system 180 can determine one or more appropriate actions (e.g., stop, speed up, change lanes, slow down, etc.) or navigation instructions to be projected by the HUD component 100.

In one or more embodiments, the system 500 can include a view management component (not shown) that manages one or more aspects of one or more graphic elements projected by the HUD component 100. In one or more embodiments, the controller component 104 can be configured to manage one or more of these aspects or functionality associated with the vehicle control component 180. For example, the controller component 104 can be configured to receive one or more road conditions.

The controller component 104 may be configured to determine a type of graphic element to be displayed, projected, animated, rendered, etc. by the HUD component 100. As an example, when a vehicle is travelling along one or more portions of a route that include relatively straight road segments, the controller component 104 may project a graphic element to be an avatar. The avatar may appear or be projected as a vehicle or a guide vehicle. In a scenario where a vehicle is travelling along one or more portions of a route that include one or more turns or other navigation maneuvers, the controller component 104 may command the HUD component 100 project a graphic element to be a marker at a location associated with one or more of the turns. For example, if a route includes a right turn from a first street onto a second street, the controller component 104 may command the HUD component 100 to project a marker or identifier at, to, around, etc. the intersection of the first street and the second street. In this way, the controller component 104 may be configured to determine one or more types (e.g., markers, identifiers, flag poles, guide avatars, etc.) of graphic elements to be displayed.

Additionally, the controller component 104 can be configured to determine one or more locations where a graphic element will be projected. In other words, the controller component 104 can decide when and where a graphic element will be projected or how the graphic element will be displayed. A location of a graphic element can include a focal plane, a distance of the focal plane from the vehicle or windshield thereof, x-coordinates, y-coordinates, z-coordinates, etc. along an x, y, or z axis, for example. This location may be called a target position for one or more of the graphic elements. In one or more embodiments, the controller component 104 can be configured to adjust a distance between one or more of the focal planes of one or more of the graphic elements and the vehicle (e.g., or windshield of the vehicle) based on one or more road conditions associated with one or more portions of the route, a current position of the vehicle, a current velocity of the vehicle, etc.

That is, if a road segment (e.g., portion of a route where a vehicle is currently located or positioned) is associated with a 65 mph speed limit (e.g., a road condition), and a current velocity (e.g., detected by the sensor component 570) of the vehicle is 25 mph (e.g., current velocity of the vehicle), the controller component 104 can be configured to command the HUD component 100 to project an avatar or graphic element which appears to be travelling at about 65 mph. In one or more embodiments, the avatar may be projected in a manner which demonstrates gradual acceleration from 25 mph to 65 mph. This means that a distance between the focal plane of the avatar and the vehicle may be adjusted accordingly. For example, in a scenario where the vehicle accelerates at approximately the same pace, the distance between the focal plane and the vehicle may remain about the same. If the vehicle accelerates at a slower pace than the avatar, that distance between the focal plane and the vehicle may be adjusted to increase by the controller component 104. In any event, this adjustment may be based on a current position of the vehicle or a current velocity of the vehicle, as well as road conditions of the route associated therewith.

Additionally, the controller component 104 may be configured to adjust or determine a size of a graphic element according to or based on a distance of the focal plane of the graphic element and the vehicle with the HUD component 100. This means that the controller component 104 can adjust a height, size, width, depth, etc. of a graphic element, guide icon, or avatar based on a desired perception. For example, to make an avatar appear to speed up, the controller component 104 may adjust the size of the avatar to shrink or be reduced while projecting the avatar onto successively farther focal planes or adjusting a dynamic focal plane to be farther and farther away from the vehicle.

In one or more embodiments, the size of the graphic element may be utilized as an indicator for an importance level of a navigation instruction or message. In other words, the more important the message or navigation instruction, the bigger the avatar, icon, or graphic element will be projected.

The controller component 104 can be configured to determine one or more actions for one or more of the graphic elements to be projected by the HUD component 100. For example, the controller component 104 may command the HUD component 100 to project an avatar to speed up, slow down, stop, change lanes, activate a turn signal prior to changing lanes, flash, blink, change an orientation or angle of an avatar, change a color of an avatar, etc. Further, the controller component 104 may adjust target positions for one or more of the graphic elements based on road conditions, a current position of the vehicle, a current velocity of the vehicle, or other attributes, characteristics, or measurements. In one or more embodiments, the controller component 104 can interface or communicate with the navigation component 540 across one or more CANs 580.

The controller component 104 may be configured to mitigate obstructions, distractions, or other aspects which may impede a driver or occupant of a vehicle. In one or more embodiments, the controller component 104 can be configured to receive a location of the horizon, such as from sensor component 570, and project graphic elements above the horizon or sky plane, etc. The controller component may be configured to determine or adjust a color, transparency, or shading of one or more graphic elements based on a time of day, traffic levels associated with the route, a familiarity the driver has with the route, etc.

The depth map component 550 can be configured to build or receive a depth map of an environment around or surrounding the vehicle, such as an operating environment. The HUD component 100 can utilize the depth map to project one or more graphic elements accordingly. This means that if an avatar turns a corner and is ‘behind’ a building (e.g., a building is between the line of sight of an occupant of the vehicle and a perceived or target location of the graphic element or avatar), the HUD component 100 can enable or disable projection of one or more portions of the avatar or graphic elements in line with what should be seen.

The depth map component 550 may be configured to receive a depth map from a server or third party server. For example, the depth map component 550 can download a depth map from a server via a telematics channel initiated via a telematics component (not shown). In other embodiments, the sensor component 570 can be configured to detect depth information which can be used to build the depth map by the depth map component 550. That is, the depth map component 550 can interface or communicate with one or more sensors to build the depth map or receive a pre-built depth map from a database. In any event, the depth map component 550 can build or receive a depth map based on depth information. The depth map can be indicative of distances of one or more surfaces, objects, obstructions, geometries, etc. in the environment or area around the vehicle.

The depth map may be passed or transmitted to the controller component 104, which can command the HUD component 100 to render one or more of the graphic elements accordingly. For example, the HUD component 100 can project or render graphic elements based on a height of an eye box associated with an occupant of a vehicle, a location of the vehicle, and a depth map of the area, which may be actively sensed or received from a database. The HUD component 100 can thus project one or more of the graphic elements based on the depth map to account for a perspective of one or more occupants of the vehicle.

The depth buffering component 560 can be configured to facilitate perspective management for one or more occupants of the vehicle utilizing the depth map generated or receive by the depth map component 550. That is, the depth buffering component can be configured to facilitate rendering of graphic elements such that the graphic elements appear visually ‘correct’ to an occupant. For example, if a graphic element is to be projected behind a real world object, the depth buffering component 560 can ‘hide’ a portion of the graphic element from an occupant by not projecting or rendering that portion of the graphic element. In other words, the depth buffering component 560 can manage which portions (e.g., pixels) of a graphic element are drawn, projected, or rendered, and which portions are not. To this end, the depth buffering component 560 can be configured to enable or disable rendering of one or more portions of one or more of the graphic elements based on the depth map.

Additionally, the depth buffering component 560 can be configured to obscure real world objects, thereby inhibiting what an occupant of a vehicle may see. For example, the depth buffering component 560 may command the HUD component 100 to project a white graphic element such that the graphic element overlays a real world object, such as a billboard (e.g., detected by sensor component 570). As a result, an occupant may not see the billboard or have an obscured view of the billboard. In this way, the depth buffering component can be configured to mitigate distractions for a driver or an occupant of a vehicle by providing graphic elements that facilitate diminished reality.

Examples of navigation instructions that can be projected by the HUD component 100 include following a guide vehicle, speeding up (e.g., changing a dynamic focal plane to have an increased distance from the focal plane to the vehicle, thereby adjusting a near-far perception a driver or occupant may have of the graphic element), slowing down (e.g., adjusting the distance between a focal plane and the vehicle to be reduced), changing lanes (e.g., adjusting a target position for a graphic element), navigating around obstructions, turning, arrival, marking a location, etc. As an example, the controller component 104 may command the HUD component 100 to project an avatar to ‘slow down’ if a pedestrian steps out onto the road segment, road way, crosswalk, etc. As another example, the controller 104 may command the HUD component 100 to project deceleration based on an angle of a turn, a speed limit associated with a road segment, road conditions, such as ice, etc. That is, if there is ice on the road surface, the controller 104 may command the HUD component 100 to project an avatar moving slower than if no ice were present on the road surface.

In one or more embodiments, the controller component 100 can mark or identify an upcoming turn or intersection with a marker, flag post, flag pole, identifier, etc. For example, the HUD component 100 can render or project a placeholder or marker according to the perspective of the occupant of the vehicle. The depth map component 550 may be configured to provide a depth map such that real life objects, such as buildings, trees, etc. act as line of sight blockers for one or more portions of the placeholder. As an example, if a placeholder has a perceived height of 100 feet, and a 50 foot tall building is in front of the placeholder, the depth buffering component 560 may compensate for the line of sight blocking by disabling rendering or projection of a bottom portion of the placeholder graphic element, thereby rendering the placeholder according to the perspective of the driver or occupant.

In one or more embodiments, one or more of the graphic elements are projected in view of an occupant of the vehicle based on the route (e.g., a follow a guide vehicle mode). In one or more embodiments, graphic element can be projected as an avatar or other guide icon. The avatar may appear to be flying and be displayed against a real world environment around the vehicle. The avatar can move, travel, or ‘fly’ in 3-D space or in three dimensions. Because of this, the avatar or graphic element may appear to move in 3-D, thereby providing a more intuitive feel or secure feeling for an occupant or driver following the avatar. As an example, an avatar, graphic element, or guide icon may be projected such that it appears to change in height or size based on a perceived distance from an occupant of the vehicle. The avatar may be animated by sequentially projecting the moving avatar on one or more different focal planes. Additionally, the avatar could appear to navigate around obstructions, obstacles, pedestrians, debris, potholes, etc. as a real vehicle would. In one or more embodiments, the avatar could ‘drive’, move, appear to move, etc. according to real-time traffic. The avatar may change lanes in a manner such that the avatar does not appear to ‘hit’ another vehicle or otherwise interfere with traffic. As another example, if a route takes a driver or a vehicle across train tracks, the avatar may stop at the train tracks when a train is crossing. In other embodiments, the HUD component 100 can be configured to project the avatar or graphic element to stop at stop signs, red lights, or obey traffic laws. Upon arrival at a destination location, the HUD component 100 can be configured to render or project an avatar in a resting pose, for example.

In this way, the system 500 for 3-D navigation can generate an intuitive message, instruction, or command for an occupant of a vehicle, such as a driver. The instruction can be based on one or more aspects related to perspective, as provided by the ability of the HUD component to project or render volumetric, 3-D graphic elements along one or more adjustable focal planes. For example, the 3-D effect can be determined based on distance, perspective, perceived distance, road conditions, etc.

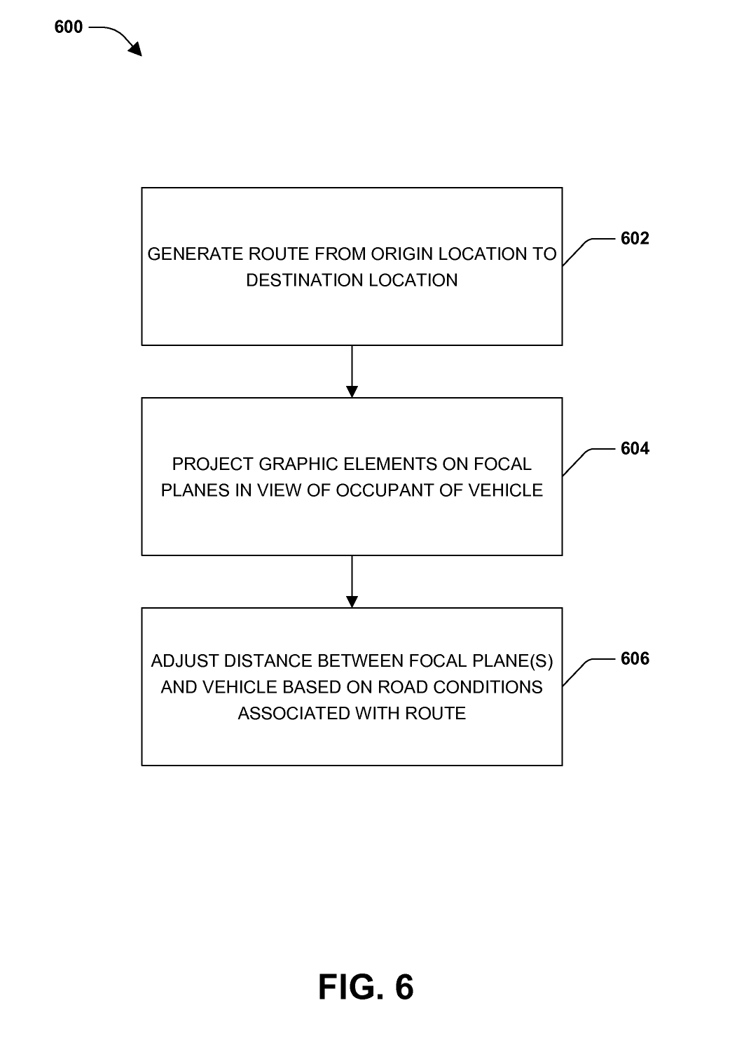

FIG. 6 is an illustration of an example flow diagram of a method 600 for 3-D navigation, according to one or more embodiments. At 602, a route can be generated from an origin location to a destination location. In one or more embodiments, the origin location or the destination location can be received via a telematics channel, such as from a global positioning system (GPS) unit. At 604, one or more graphic elements can be projected on one or more focal planes in view of an occupant of a vehicle. Here, graphic elements may be displayed as avatars, images, icons, identifiers, markers, etc. Additionally, these graphic elements can be based on one or more portions of the route. This means that these graphic elements may be projected at various distances depending on the portion of the route at which a vehicle may be located (e.g., a current position of the vehicle).

At 606, a distance between a focal plane and the vehicle may be adjusted based on road conditions associated with one or more portions of the route. Further, the distance may also be adjusted based on a current velocity of the vehicle. For example, if a vehicle traveling along a portion of a route associated with a 65 mile per hour (mph) speed limit and the current velocity of the vehicle is 25 mph, the distance of between the focal plane of a projected graphic element or avatar may be increased (e.g., to indicate to the driver or occupant to speed up). In other words, the graphic element may be projected to appear as if it were travelling about 65 mph, thereby prompting the occupant or driver to speed up and ‘catch’ the avatar (e.g., similar or simulating following a guide vehicle).

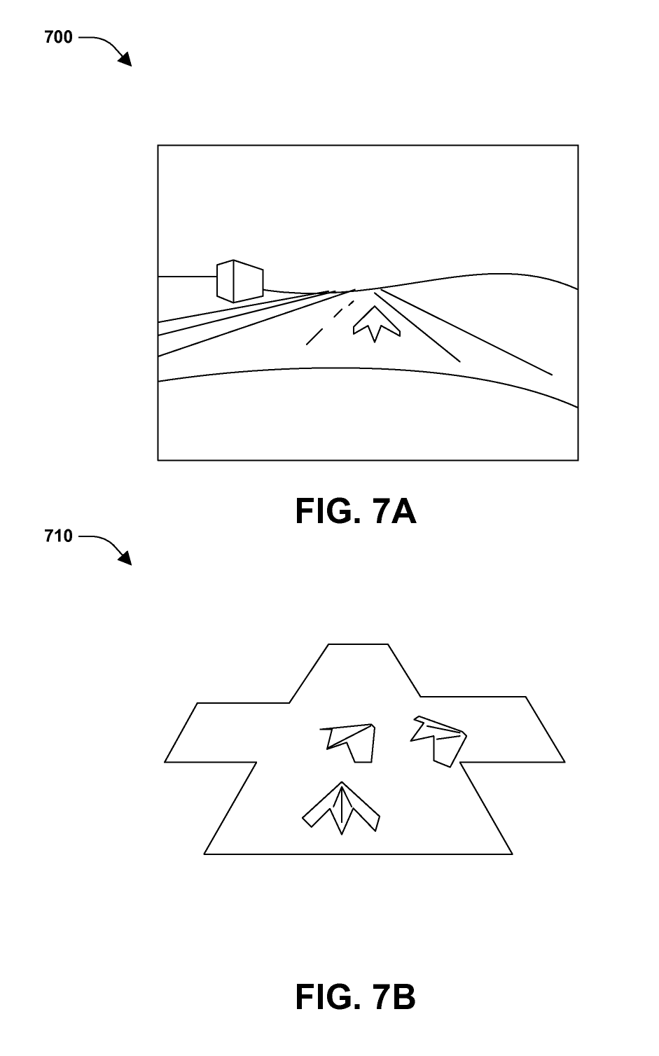

FIG. 7A is an illustration of an example avatar 700 for 3-D navigation, according to one or more embodiments. The avatar 700 of FIG. 7A may appear in front of a vehicle and fly, glide, move, maneuver, etc. around elements, obstructions, traffic, road conditions, etc. FIG. 7B is an illustration of an example avatar(s) 710 for 3-D navigation, according to one or more embodiments. The avatar(s) 710 of FIG. 7B are seen from an elevated view, such as a birds-eye view slightly behind the avatars(s) 710. It can be seen that one or more of the avatars 710 are projected on one or more different focal planes or target positions, thereby providing the perception that a driver or occupant is following a real vehicle.

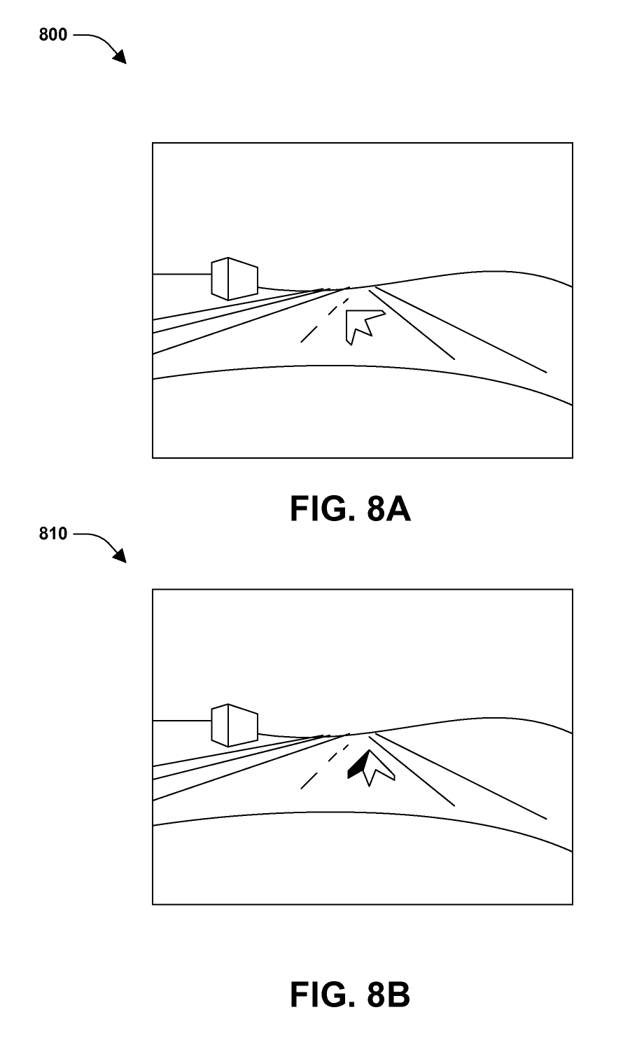

FIG. 8A is an illustration of an example avatar 800 for 3-D navigation, according to one or more embodiments. The avatar 800 of FIG. 8A is rotated counterclockwise to indicate a left turn. FIG. 8B is an illustration of an example avatar 810 for 3-D navigation, according to one or more embodiments. In one or more embodiments, the avatar 810 of FIG. 8B can indicate a left turn by blinking, flashing, changing color, etc. For example, the left wing of the paper airplane avatar 810 may glow or change in intensity to indicate the upcoming left turn. In one or more embodiments, an avatar may be projected on focal planes closer to the vehicle such that it appears that the avatar is ‘slowing down’ prior to making a turn.

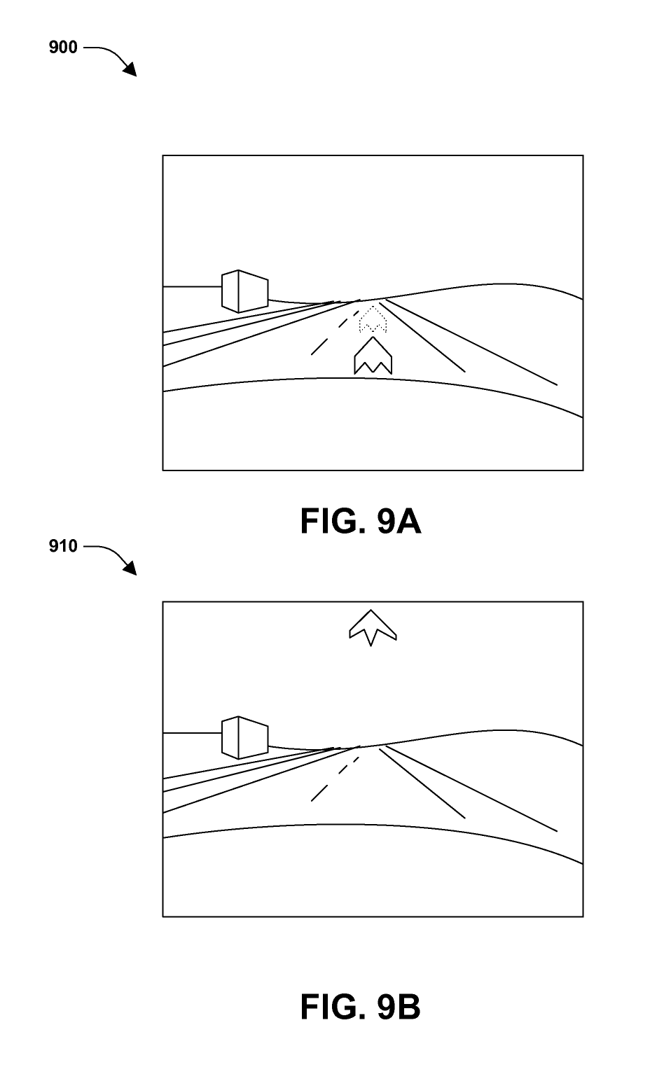

FIG. 9A is an illustration of an example avatar 900 for 3-D navigation, according to one or more embodiments. FIG. 9B is an illustration of an example avatar 910 for 3-D navigation, according to one or more embodiments. The avatar 900 of FIG. 9A can be projected as a navigation instruction for a driver of a vehicle to slow down, for example. In FIG. 9B, the avatar 910 is projected above the horizon or a sky plane such that the avatar 910 does not obstruct the driver or occupant from viewing one or more portions of the environment around the vehicle.

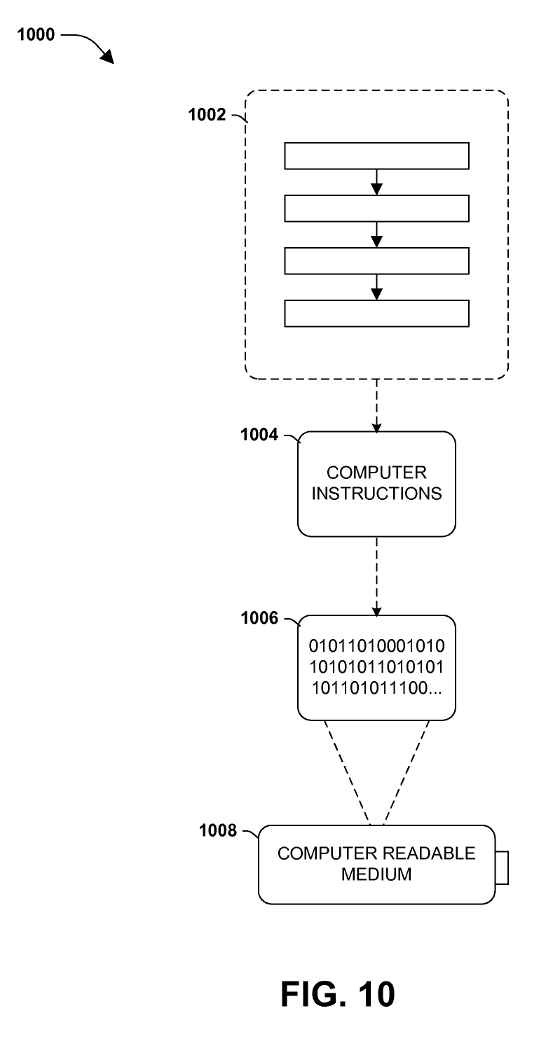

Still another embodiment involves a computer-readable medium including processor-executable instructions configured to implement one or more embodiments of the techniques presented herein. An embodiment of a computer-readable medium or a computer-readable device that is devised in these ways is illustrated in FIG. 10, wherein an implementation 1000 includes a computer-readable medium 1008, such as a CD-R, DVD-R, flash drive, a platter of a hard disk drive, etc., on which is encoded computer-readable data 1006. This computer-readable data 1006, such as binary data including a plurality of zeros or ones as shown in 1006, in turn includes a set of computer instructions 1004 configured to operate according to one or more of the principles set forth herein. In one such embodiment 1000, the processor-executable computer instructions 1004 are configured to perform a method 1002, such as the method 600 of FIG. 6. In another embodiment, the processor-executable instructions 1004 are configured to implement a system, such as the system 500 of FIG. 5. Many such computer-readable media are devised by those of ordinary skill in the art that are configured to operate in accordance with the techniques presented herein.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, or a computer. By way of illustration, both an application running on a controller and the controller can be a component. One or more components residing within a process or thread of execution and a component may be localized on one computer or distributed between two or more computers.

Further, the claimed subject matter is implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

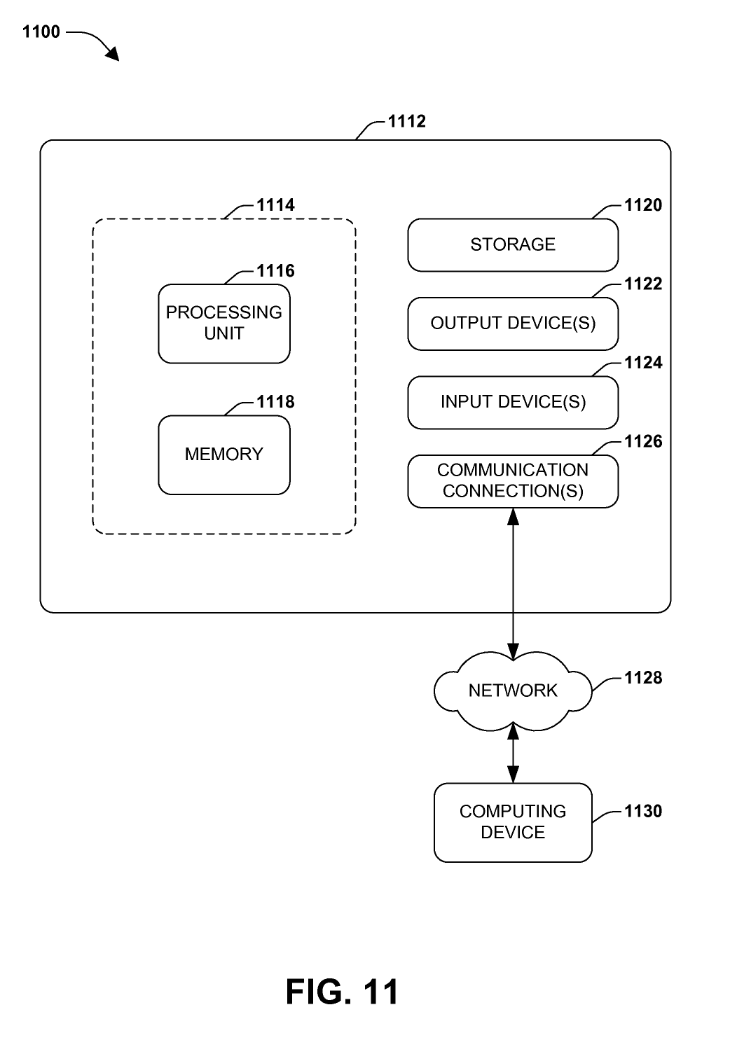

FIG. 11 and the following discussion provide a description of a suitable computing environment to implement embodiments of one or more of the provisions set forth herein. The operating environment of FIG. 11 is merely one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, and the like, multiprocessor systems, consumer electronics, mini computers, mainframe computers, distributed computing environments that include any of the above systems or devices, and the like.

Generally, embodiments are described in the general context of “computer readable instructions” being executed by one or more computing devices. Computer readable instructions are distributed via computer readable media as will be discussed below. Computer readable instructions are implemented as program modules, such as functions, objects, Application Programming Interfaces (APIs), data structures, and the like, that perform one or more tasks or implement one or more abstract data types. Typically, the functionality of the computer readable instructions are combined or distributed as desired in various environments.

FIG. 11 illustrates a system 1100 including a computing device 1112 configured to implement one or more embodiments provided herein. In one configuration, computing device 1112 includes one or more processing units 1116 and memory 1118. Depending on the exact configuration and type of computing device, memory 1118 may be volatile, such as RAM, non-volatile, such as ROM, flash memory, etc., or a combination of the two. This configuration is illustrated in FIG. 11 by dashed line 1114.

In other embodiments, device 1112 includes additional features or functionality. For example, device 1112 can include additional storage such as removable storage or non-removable storage, including, but not limited to, magnetic storage, optical storage, and the like. Such additional storage is illustrated in FIG. 11 by storage 1120. In one or more embodiments, computer readable instructions to implement one or more embodiments provided herein are in storage 1120. Storage 1120 can store other computer readable instructions to implement an operating system, an application program, and the like. Computer readable instructions are loaded in memory 1118 for execution by processing unit 1116, for example.

The term “computer readable media” as used herein includes computer storage media. Computer storage media includes volatile and nonvolatile, removable and non-removable media implemented in any method or technology for storage of information such as computer readable instructions or other data. Memory 1118 and storage 1120 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 1112. Any such computer storage media is part of device 1112.

The term “computer readable media” includes communication media. Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal.

Device 1112 includes input device(s) 1124 such as keyboard, mouse, pen, voice input device, touch input device, infrared cameras, video input devices, or any other input device. Output device(s) 1122 such as one or more displays, speakers, printers, or any other output device may be included with device 1112. Input device(s) 1124 and output device(s) 1122 are connected to device 1112 via a wired connection, wireless connection, or any combination thereof. In one or more embodiments, an input device or an output device from another computing device are used as input device(s) 1124 or output device(s) 1122 for computing device 1112. Device 1112 can include communication connection(s) 1126 to facilitate communications with one or more other devices.

According to one or more aspects, a system for 3-dimensional (3-D) navigation is provided, including a navigation component configured to receive an origin location and a destination location. The navigation component can be associated with a vehicle and configured to generate a route from the origin location to the destination location. One or more portions of the route can include one or more navigation instructions associated with one or more road segments or one or more intersections of the road segments. The system can include a heads-up display (HUD) component configured to project one or more graphic elements on one or more focal planes around an environment surrounding the vehicle. The HUD component can be configured to project one or more of the graphic elements in view of an occupant of the vehicle based on the route. The system can include a controller component configured to adjust a distance between one or more of the focal planes of one or more of the graphic elements and the vehicle based on one or more road conditions associated with one or more portions of the route and a current position of the vehicle.

In one or more embodiments, the controller component can be configured to adjust a target position for one or more of the graphic elements based on one or more of the road conditions and the current position of the vehicle. The system can include a vehicle control component configured to receive one or more of the road conditions. Additionally, the system can include a sensor component configured to detect one or more of the road conditions. A road condition of the one or more road conditions can include traffic information of one or more of the road segments or speed limit information associated with one or more of the road segments. Additionally, road conditions may include an obstruction, an obstacle, a pedestrian, debris, or a pothole, for example.

The system can include a depth map component configured to build a depth map of the environment surrounding the vehicle. The HUD component can be configured to project one or more of the graphic elements based on the depth map of the environment. The depth map component may be configured to build the depth map based on depth information. In one or more embodiments, the system can include a sensor component configured to detect depth information from the environment surrounding the vehicle. The depth map component may be configured to receive the depth map based on a telematics channel. The system can include a depth buffering component configured to enable or disable rendering of one or more portions of one or more of the graphic elements based on the depth map.

The HUD component may be configured to project one or more graphic elements as a moving avatar or as a placeholder, such as a flag pole, marker, identifier, etc.

According to one or more aspects, a method for 3-dimensional (3-D) navigation is provided, including generating a route from an origin location to a destination location for a vehicle. One or more portions of the route can include one or more navigation instructions associated with one or more road segments or one or more intersections of the road segments. The method can include projecting one or more graphic elements on one or more focal planes around an environment surrounding the vehicle. One or more of the graphic elements may be projected in view of an occupant of the vehicle based on the route. The method can include adjusting a distance between one or more of the focal planes of one or more of the graphic elements and the vehicle based on one or more road conditions associated with one or more portions of the route and a current position of the vehicle. One or more portions of the method can be implemented via a processing unit.

The method can include adjusting a target position for one or more of the graphic elements based on one or more of the road conditions and the current position of the vehicle. The method can include receiving or detecting one or more of the road conditions. A road condition of the one or more road conditions can include traffic information of one or more of the road segments, speed limit information associated with one or more of the road segments, an obstruction, an obstacle, a pedestrian, debris, or a pothole.

The method can include building a depth map of the environment surrounding the vehicle, projecting one or more of the graphic elements based on the depth map of the environment, detecting depth information from the environment surrounding the vehicle, building the depth map based on the detected depth information, enabling or disabling rendering of one or more portions of one or more of the graphic elements based on the depth map, among other things.

According to one or more aspects, a computer-readable storage medium including computer-executable instructions, which when executed via a processing unit on a computer performs acts, including generating a route from an origin location to a destination location for a vehicle, wherein one or more portions of the route include one or more navigation instructions associated with one or more road segments or one or more intersections of the road segments, projecting one or more graphic elements on one or more focal planes around an environment surrounding the vehicle, wherein one or more of the graphic elements are projected in view of an occupant of the vehicle based on the route, or adjusting a distance between one or more of the focal planes of one or more of the graphic elements and the vehicle based on one or more road conditions associated with one or more portions of the route and a current position of the vehicle.

In one or more embodiments, projecting one or more of the graphic elements utilizes rastor based graphics. Additionally, one or more of the embodiments can include providing one or more of the navigation instructions via projecting one or more of the graphic elements as a moving avatar or animating the moving avatar by sequentially projecting the moving avatar on one or more different focal planes.

Although the subject matter has been described in language specific to structural features or methodological acts, it is to be understood that the subject matter of the appended claims is not necessarily limited to the specific features or acts described above. Rather, the specific features and acts described above are disclosed as example embodiments.

Various operations of embodiments are provided herein. The order in which one or more or all of the operations are described should not be construed as to imply that these operations are necessarily order dependent. Alternative ordering will be appreciated based on this description. Further, not all operations may necessarily be present in each embodiment provided herein.

As used in this application, “or” is intended to mean an inclusive “or” rather than an exclusive “or”. In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising”.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel.

Although the disclosure has been shown and described with respect to one or more implementations, equivalent alterations and modifications will occur based on a reading and understanding of this specification and the annexed drawings. The disclosure includes all such modifications and alterations and is limited only by the scope of the following claims.

What is claimed is:

1. A system for 3-dimensional (3-D) navigation, comprising:
a navigation component configured to:
receive an origin location and a destination location, the navigation component associated with a vehicle; and
generate a route from the origin location to the destination location, wherein one or more portions of the route comprise one or more navigation instructions associated with one or more road segments or one or more intersections of the road segments;
a heads-up display (HUD) component projecting one or more graphic elements on one or more focal planes around an environment surrounding the vehicle, wherein one or more of the graphic elements are projected in view of an occupant of the vehicle based on the route; and
a controller component adjusting a distance between one or more of the focal planes of one or more of the graphic elements and the vehicle based on one or more road conditions associated with one or more portions of the route and a current position of the vehicle.

2. The system of claim 1, wherein the controller component adjusts a target position for one or more of the graphic elements based on one or more of the road conditions and the current position of the vehicle.

3. The system of claim 1, comprising a vehicle control component receiving one or more of the road conditions, wherein a road condition of the one or more road conditions comprises traffic information of one or more of the road segments or speed limit information associated with one or more of the road segments.

4. The system of claim 1, comprising a sensor component detecting one or more of the road conditions, wherein a road condition of the one or more road conditions comprises an obstruction, an obstacle, a pedestrian, debris, or a pothole.

5. The system of claim 1, comprising a depth map component building a depth map of the environment surrounding the vehicle, the HUD component projecting one or more of the graphic elements based on the depth map of the environment.

6. The system of claim 5, comprising a sensor component detecting depth information from the environment surrounding the vehicle, wherein the depth map component builds the depth map based on the depth information.

7. The system of claim 5, wherein the depth map component receives the depth map based on a telematics channel.

8. The system of claim 5, comprising a depth buffering component that enables or disables rendering of one or more portions of one or more of the graphic elements based on the depth map.

9. The system of claim 1, wherein the HUD component projects one or more graphic elements as a moving avatar.

10. The system of claim 1, wherein the HUD component projects one or more of the graphic elements as a placeholder.

11. A method for 3-dimensional (3-D) navigation, comprising:
generating a route from an origin location to a destination location for a vehicle, wherein one or more portions of the route comprise one or more navigation instructions associated with one or more road segments or one or more intersections of the road segments;
projecting one or more graphic elements on one or more focal planes around an environment surrounding the vehicle, wherein one or more of the graphic elements are projected in view of an occupant of the vehicle based on the route; and
adjusting a distance between one or more of the focal planes of one or more of the graphic elements and the vehicle based on one or more road conditions associated with one or more portions of the route and a current position of the vehicle, wherein the generating or the adjusting is implemented via a processing unit.

12. The method of claim 11, comprising adjusting a target position for one or more of the graphic elements based on one or more of the road conditions and the current position of the vehicle.

13. The method of claim 11, comprising receiving or detecting one or more of the road conditions, wherein a road condition of the one or more road conditions comprises traffic information of one or more of the road segments, speed limit information associated with one or more of the road segments, an obstruction, an obstacle, a pedestrian, debris, or a pothole.

14. The method of claim 11, comprising:
building a depth map of the environment surrounding the vehicle; and
projecting one or more of the graphic elements based on the depth map of the environment.

15. The method of claim 14, comprising:
detecting depth information from the environment surrounding the vehicle; and
building the depth map based on the detected depth information.

16. The method of claim 14, comprising enabling or disabling rendering of one or more portions of one or more of the graphic elements based on the depth map.

17. A computer-readable storage medium comprising computer-executable instructions, which when executed via a processing unit on a computer performs acts, comprising:
generating a route from an origin location to a destination location for a vehicle, wherein one or more portions of the route comprise one or more navigation instructions associated with one or more road segments or one or more intersections of the road segments;
projecting one or more graphic elements on one or more focal planes around an environment surrounding the vehicle, wherein one or more of the graphic elements are projected in view of an occupant of the vehicle based on the route; and
adjusting a distance between one or more of the focal planes of one or more of the graphic elements and the vehicle based on one or more road conditions associated with one or more portions of the route and a current position of the vehicle.

18. The computer-readable storage medium of claim 17, wherein projecting one or more of the graphic elements utilizes rastor based graphics.

19. The computer-readable storage medium of claim 17, comprising providing one or more of the navigation instructions via projecting one or more of the graphic elements as a moving avatar.

20. The computer-readable storage medium of claim 19, comprising animating the moving avatar by sequentially projecting the moving avatar on one or more different focal planes.
